(19) United States
(12) Patent Application Publication
(10) Pub. No.: US 2026/0213976 A1
(43) Pub. Date: Jul. 23, 2026

(54) RELAY METHOD, RELAY DEVICE, AND RECORDING MEDIUM

(71) Applicant: Panasonic Intellectual Property Management Co., Ltd., Osaka (JP)

(72) Inventors: Yuki UEMOTO, Fukuoka (JP); Yoshihiro UJIIE, Tokyo (JP); Junichi TSURUMI, Osaka (JP)

(73) Assignee: Panasonic Intellectual Property Management Co., Ltd., Osaka (JP)

(21) Appl. No.: 19/569,495

(22) Filed: Mar. 17, 2026

Related U.S. Application Data
(63) Continuation of application No. PCT/JP2024/033231, filed on Sep. 18, 2024.

(30) Foreign Application Priority Data
Sep. 29, 2023 (JP) 2023-170351

(51) Int. Cl. H04L 12/46; H04L 12/64; H04L 67/12

(52) U.S. Cl. CPC H04L 12/4604; H04L 12/6418; H04L 67/12; H04L 2012/647

(57) ABSTRACT

A relay method is executed by a relay device in an internal network of a mobile object. The internal network includes a plurality of electronic control units that transmit and receive frames to and from each other via the relay device. The relay method includes: classifying the plurality of electronic control units into a plurality of segments according to a state of the mobile object; and controlling transmission and reception of frames between the plurality of segments.

### CROSS REFERENCE TO RELATED APPLICATIONS

This is a continuation application of PCT International Application No. PCT/JP2024/033231 filed on Sep. 18, 2024, designating the United States of America, which is based on and claims priority of Japanese Patent Application No. 2023-170351 filed on Sep. 29, 2023. The entire disclosures of the above-identified applications, including the specifications, drawings and claims are incorporated herein by reference in their entirety.

### FIELD

The present disclosure relates to a relay method, a relay device, and a recording medium.

### BACKGROUND

There are technologies concerning vehicle gateway systems, which constitute part of communication systems.

For example, Patent Literature (PTL) 1 discloses a vehicle gateway device that records information obtained through communication with outside of the vehicle if the information is software update information, and transfers the information if the information is determined not to be vehicle-related information.

### CITATION LIST

### Patent Literature

PTL 1: Japanese Patent No. 5382131

### SUMMARY

### Technical Problem

If a remote attacker takes control of any of in-vehicle devices, the attacker may launch an attack on another device by transmitting software update information over the local network. With the background-art technology, it is difficult to prevent such attack because the information is transmitted as soon as it is determined to be software update information. Thus, the background-art technology has the problem in that it is difficult to suppress security attacks in a local network of a mobile object.

In view of the above, the present disclosure provides a relay method, a relay device, and a recording medium that are capable of suppressing security attacks in a local network of a mobile object.

### Solution to Problem

A relay method according to an aspect of the present disclosure is a relay method executed by a relay device in an internal network of a mobile object, the internal network including a plurality of electronic control units that transmit and receive frames to and from each other via the relay device, the relay method including: classifying the plurality of electronic control units into a plurality of segments according to a state of the mobile object; and controlling transmission and reception of frames between the plurality of segments.

A relay device according to an aspect of the present disclosure is a relay device in an internal network of a mobile object, the internal network including a plurality of electronic control units that transmit and receive frames to and from each other via the relay device, the relay device: classifying the plurality of electronic control units into a plurality of segments according to a state of the mobile object; and controlling transmission and reception of frames between the plurality of segments.

A recording medium according to an aspect of the present disclosure is a non-transitory computer-readable recording medium having recorded thereon a computer program for causing a computer to execute the foregoing relay method.

These general and specific aspects may be implemented using a system, a device, an integrated circuit, a computer program, or a computer-readable recording medium such as CD-ROM, or any combination of a system, a device, an integrated circuit, a computer program, and a recording medium.

### Advantageous Effects

A relay method, etc. according to the present disclosure are capable of suppressing attacks in a local network of a mobile object.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a schematic diagram illustrating the configuration of a communication system in Embodiment 1.

FIG. 2 is a block diagram illustrating the configuration of a network device in Embodiment 1.

FIG. 3 is an explanatory diagram illustrating a state notification frame in Embodiment 1.

FIG. 4 is an explanatory diagram illustrating a mobile object state list in Embodiment 1.

FIG. 5 is an explanatory diagram illustrating a segment list in Embodiment 1.

FIG. 6 is an explanatory diagram illustrating a segment setting table in Embodiment 1.

FIG. 7 is a flowchart illustrating a segment setting method by the network device in Embodiment 1.

FIG. 8 is a sequence diagram illustrating segment update operation in the communication system in Embodiment 1.

FIG. 9 is an explanatory diagram illustrating a transfer control table for controlling transfer of frames by the network device in Embodiment 1.

FIG. 10 is an explanatory diagram illustrating a frame rejection table for controlling transfer of frames by the network device in Embodiment 1.

FIG. 11 is a flowchart illustrating a frame transfer method by the network device in Embodiment 1.

FIG. 12 is a first sequence diagram illustrating frame transfer operation in the communication system in Embodiment 1.

FIG. 13 is a second sequence diagram illustrating frame transfer operation in the communication system in Embodiment 1.

FIG. 14 is a schematic diagram illustrating the configuration of a communication system in Embodiment 2.

FIG. 15 is an explanatory diagram illustrating an update frame in Embodiment 2.

FIG. 16 is an explanatory diagram illustrating a segment setting table in Embodiment 2.

FIG. 17 is a sequence diagram illustrating segment update operation in the communication system in Embodiment 2.

FIG. 18 is an explanatory diagram illustrating a transfer control table for controlling transfer of frames by a network device in Embodiment 2.

FIG. 19 is a first sequence diagram illustrating frame transfer operation in the communication system in Embodiment 2.

FIG. 20 is a second sequence diagram illustrating frame transfer operation in the communication system in Embodiment 2.

FIG. 21 is a schematic diagram illustrating the configuration of a communication system in Embodiment 3.

FIG. 22 is an explanatory diagram illustrating a charge/discharge control frame in Embodiment 3.

FIG. 23 is an explanatory diagram illustrating a segment setting table in Embodiment 3.

FIG. 24 is a sequence diagram illustrating segment update operation in the communication system in Embodiment 3.

FIG. 25 is an explanatory diagram illustrating a transfer control table for controlling transfer of frames by a network device in Embodiment 3.

FIG. 26 is a first sequence diagram illustrating frame transfer operation in the communication system in Embodiment 3.

FIG. 27 is a second sequence diagram illustrating frame transfer operation in the communication system in Embodiment 3.

FIG. 28 is a third sequence diagram illustrating frame transfer operation in the communication system in Embodiment 3.

### DESCRIPTION OF EMBODIMENTS

A relay method according to a first aspect of the present disclosure is a relay method executed by a relay device in an internal network of a mobile object, the internal network including a plurality of electronic control units that transmit and receive frames to and from each other via the relay device, the relay method including: classifying the plurality of electronic control units into a plurality of segments according to a state of the mobile object; and controlling transmission and reception of frames between the plurality of segments.

Thus, since transmission and reception of frames between the plurality of segments classified according to the state of the mobile object is controlled, it is possible to control whether frames can be transferred depending on the state of the mobile object. In other words, it is possible to suppress unauthorized frames from being communicated between segments in the state of the mobile object. The relay method can therefore suppress security attacks in the local network of the mobile object. An example of the unauthorized frames is a frame that a remote attacker who has taken control of some device inside the mobile object transmits in order to launch an attack on another device using the local network.

For example, a relay method according to a second aspect of the present disclosure may be the relay method according to the first aspect, wherein the state of the mobile object includes a travel state of the mobile object, and in the classifying, when the travel state indicates that the mobile object is traveling, the plurality of electronic control units are classified into a first segment related to travel and one or more second segments other than the first segment.

Thus, when the state of the mobile object is the travel state, security attacks in the local network of the mobile object can be suppressed.

For example, a relay method according to a third aspect of the present disclosure may be the relay method according to the first aspect or the second aspect, wherein the state of the mobile object includes a software update state of the mobile object, and in the classifying, when the software update state indicates that software of the mobile object is being updated, the plurality of electronic control units are classified into a first segment related to update of the software and one or more second segments other than the first segment.

Thus, when the state of the mobile object is the software update state, security attacks in the local network of the mobile object can be suppressed.

For example, a relay method according to a fourth aspect of the present disclosure may be the relay method according to any one of the first aspect to the third aspect, wherein the state of the mobile object includes a charge/discharge state of a battery of the mobile object, and in the classifying, when the charge/discharge state indicates that the battery of the mobile object is being charged or discharged, the plurality of electronic control units are classified into a first segment related to charge/discharge of the battery and one or more second segments other than the first segment.

Thus, when the state of the mobile object is the charge/discharge state, security attacks in the local network of the mobile object can be suppressed.

For example, a relay method according to a fifth aspect of the present disclosure may be the relay method according to any one of the first aspect to the fourth aspect, wherein the state of the mobile object includes a travel state of the mobile object and a software update state of the mobile object, and in the classifying, when the software update state indicates that software of the mobile object is being updated and the travel state indicates that the mobile object is traveling, the plurality of electronic control units are classified into a first segment related to travel, a third segment related to update of the software, and one or more second segments other than the first segment and the third segment.

Thus, when the state of the mobile object is both the travel state and the software update state, security attacks in the local network of the mobile object can be suppressed.

For example, a relay method according to a sixth aspect of the present disclosure may be the relay method according to any one of the second aspect to the fifth aspect, wherein in the controlling, the transmission and reception of frames between the plurality of segments are controlled based on a predetermined rule for the transmission and reception of frames between the plurality of segments, the predetermined rule being in accordance with the state of the mobile object.

Thus, communication of unauthorized frames between segments can be suppressed using the predetermined rule switched according to the state of the mobile object.

For example, a relay method according to a seventh aspect of the present disclosure may be the relay method according to the sixth aspect, wherein a segment to which, among the plurality of electronic control units, an electronic control unit that has transmitted a frame determined not to be transferred based on the predetermined rule belongs is changed to any of the one or more second segments.

Thus, the electronic control unit that has transmitted the frame determined not to be transferred can be prevented from launching a security attack on another electronic control unit belonging to the same segment.

For example, a relay method according to an eighth aspect of the present disclosure may be the relay method according to the sixth aspect, wherein an instruction is output to turn off power of an electronic control unit that has transmitted a frame determined not to be transferred based on the predetermined rule among the plurality of electronic control units.

Thus, the electronic control unit that has transmitted the frame determined not to be transferred can be prevented from launching a security attack.

For example, a relay method according to a ninth aspect of the present disclosure may be the relay method according to the sixth aspect, wherein a frame transmitted by an electronic control unit that has transmitted a frame determined not to be transferred based on the predetermined rule among the plurality of electronic control units is discarded.

Thus, the electronic control unit that has transmitted the frame determined not to be transferred can be prevented from launching a security attack on an electronic control unit belonging to another segment.

For example, a relay method according to a tenth aspect of the present disclosure may be the relay method according to any one of the sixth aspect to the ninth aspect, wherein the predetermined rule includes a first rule that allows transfer of a frame from the first segment to the one or more second segments and rejects transfer of a frame from the one or more second segments to the first segment.

Thus, when frames are not to be transmitted from the second segment to the first segment in the state of the mobile object, frames transmitted from the second segment to the first segment are likely to be unauthorized frames, and accordingly transfer of such frames can be rejected.

For example, a relay method according to an eleventh aspect of the present disclosure may be the relay method according to any one of the sixth aspect to the tenth aspect, wherein the predetermined rule includes a second rule that rejects transfer of a frame of a predetermined type when the mobile object is in a predetermined state.

Thus, transfer of frames of a type that is not to be transmitted in the state of the mobile object can be rejected.

For example, a relay method according to a twelfth aspect of the present disclosure may be the relay method according to the eleventh aspect, wherein the predetermined rule further includes a first rule that allows transfer of a frame from the first segment to the one or more second segments and rejects transfer of a frame from the one or more second segments to the first segment, and determination based on the second rule is performed on a frame that has been determined, based on the first rule, to be allowed to be transferred.

Thus, whether frames can be transferred can be determined using two rules, namely the first rule and the second rule, so that security attacks in the local network of the mobile object can be more effectively suppressed than when only one rule is used.

For example, a relay method according to a thirteenth aspect of the present disclosure may be the relay method according to the twelfth aspect, wherein when a source segment and a destination segment of the frame are same, whether the frame is allowed to be transferred is determined based on only the second rule out of the first rule and the second rule.

Thus, transfer of frames can be rejected in transmission and reception of frames between electronic control units within the same segment.

For example, a relay method according to a fourteenth aspect of the present disclosure may be the relay method according to any one of the first aspect to the thirteenth aspect, wherein the plurality of segments include a travel control segment including one or more electronic control units related to travel of the mobile object, an autonomous driving control segment including one or more electronic control units related to autonomous driving of the mobile object, and one or more other segments, in the controlling, a predetermined rule for the transmission and reception of frames between the plurality of segments is used, the predetermined rule being in accordance with the state of the mobile object, and the predetermined rule includes: allowing transfer of a frame from the travel control segment and the autonomous driving control segment to the one or more other segments, and rejecting transfer of a frame from the one or more other segments to the travel control segment and the autonomous driving control segment; and allowing transfer of a frame from the autonomous driving control segment to the travel control segment, and rejecting transfer of a frame from the travel control segment to the autonomous driving control segment.

Thus, when the state of the mobile object is the autonomous driving state, traveling in autonomous driving is possible.

For example, a relay method according to a fifteenth aspect of the present disclosure may be the relay method according to any one of the first aspect to the fourteenth aspect, wherein the classifying includes, each time the state of the mobile object changes, reclassifying the plurality of electronic control units into a plurality of segments according to the state of the mobile object after the change.

Thus, even when the state of the mobile object changes, security attacks in the local network of the mobile object can be suppressed.

A relay device according to a sixteenth aspect of the present disclosure is a relay device in an internal network of a mobile object, the internal network including a plurality of electronic control units that transmit and receive frames to and from each other via the relay device, the relay device: classifying the plurality of electronic control units into a plurality of segments according to a state of the mobile object; and controlling transmission and reception of frames between the plurality of segments.

This achieves the same effects as the foregoing relay method.

A recording medium according to a seventeenth aspect of the present disclosure is a non-transitory computer-readable recording medium having recorded thereon a computer program for causing a computer to execute the relay method according to any one of the first aspect to the fifteenth aspect.

This achieves the same effects as the foregoing relay method.

Embodiments will be described in detail below with reference to the drawings.

Each of the embodiments described below shows a general or specific example. The numerical values, shapes, materials, structural elements, the arrangement and connection of the structural elements, steps, the processing order of the steps etc. illustrated in the following embodiments are mere examples, and do not limit the scope of the present disclosure. Of the structural elements in the embodiments described below, the structural elements not recited in any one of the independent claims representing the broadest concepts will be described as optional structural elements.

In the specification, the terms indicating the relationships between elements, such as “same” and “equal”, the numerical values, and the numerical ranges are not expressions of strict meanings only, but are expressions of meanings including substantially equivalent ranges, for example, allowing for a difference of about several percent (or about 10%).

In the specification, ordinal numbers such as “first” and “second” do not mean the numbers or order of structural elements unless otherwise specified, but are used for the purpose of avoiding confusion and distinguishing between structural elements of the same type.

### Embodiment 1

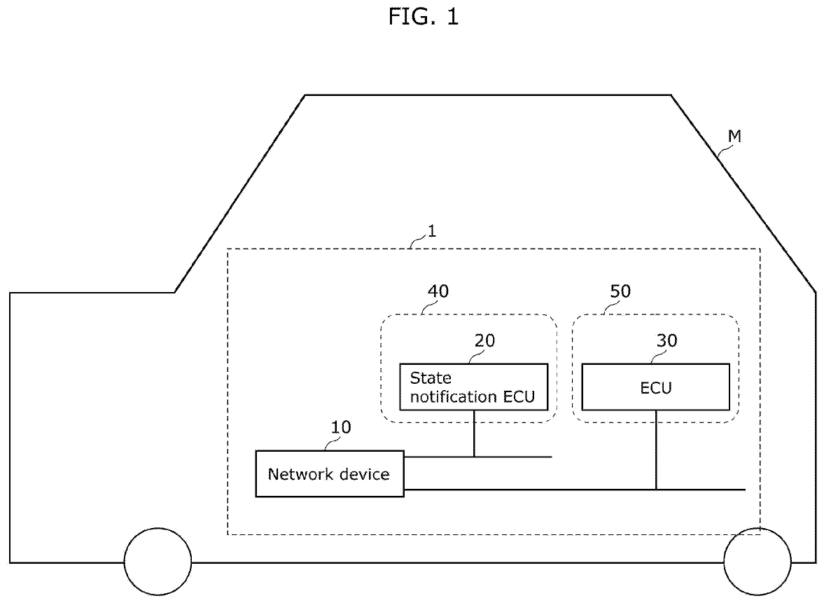

In this embodiment, a network device setting method, etc. capable of suppressing security attacks in a communication system of a mobile object will be described with reference to FIGS. 1 to 13. Here, the term “security attack” means, for example, an attack which a remote attacker who has taken control of any of the devices inside the mobile object launches on another device using the local network, or a cyberattack on the mobile object from outside the mobile object.

### 1-1. Configuration of Communication System

First, the configuration of a communication system according to this embodiment will be described with reference to FIGS. 1 to 6.

FIG. 1 is a schematic diagram illustrating the configuration of communication system 1 in this embodiment.

Communication system 1 illustrated in FIG. 1 is a communication system in a network (internal network) of mobile object M. Communication system 1 includes a plurality of devices mounted in (i.e. provided to) mobile object M and constituting the network.

Communication system 1 includes network device 10, state notification ECU 20, and ECU 30.

State notification ECU 20 and ECU 30 are electronic control units (ECUs) corresponding to devices connected to communication system 1 (hereinafter also simply referred to as devices). Communication system 1 includes a plurality of ECUs. The plurality of ECUs can transmit and receive frames to and from each other via network device 10.

Network device 10 corresponds to a device capable of communicating with each of the plurality of devices connected to communication system 1 (hereinafter also simply referred to as a device). Network device 10 is a relay device that, in the network of mobile object M, transfers a communication frame (hereinafter also simply referred to as a frame) transmitted by one of the plurality of devices to another of the plurality of devices.

The devices connected to communication system 1 are not limited to state notification ECU 20, ECU 30, and network device 10. The number of state notification ECUs 20 and the number of ECUs 30 connected to communication system 1 are not particularly limited, and are one or more.

ECU 30 controls mobile object M. Non-limiting examples of ECU 30 include ECUs that control mobile object M, such as an ECU that controls traveling of mobile object M, e.g., braking and steering, and an ECU that controls multimedia, e.g., audio and navigation.

State notification ECU 20 has a function of notifying a mobile object state, which is the state of mobile object M. Non-limiting examples of the mobile object state include a travel state of mobile object M (such as traveling (i.e. running or in motion), stopped, or autonomous driving), an over-the-air (OTA) state (such as no OTA or ECU 30 OTA in progress (i.e., OTA of ECU 30 in progress; the same applies hereinafter)), a diagnostic state (such as no diagnosis or diagnosis of ECU 30 in progress), a charge/discharge state (such as no charging/discharging, charging, or discharging), and a connection state of an information processing terminal (such as no information processing terminal being connected or a smartphone being connected). The OTA state is an example of a software update state, and “OTA in progress” means that a software update is in progress. The charge/discharge state includes a charge/discharge state of a battery mounted in mobile object M.

For example, state notification ECU 20 may obtain information of shift, braking, steering, or the like from ECU 30, and notify network device 10 of a travel state based on the obtained information.

Default segment 40 and travel control segment 50 are segments defining ranges constituting the network and serving as frame transfer ranges. Specifically, the segments may be implemented by a virtual local area network (VLAN), or implemented by segments in software-defined networking (SDN). The segments are not limited to default segment 40 and travel control segment 50.

Default segment 40 is a segment set in an initial state of network device 10, and may be a segment to which each device not subject to segment control by network device 10 belongs. For example, if none of the ECUs is subjected to segment control, all of the ECUs belong to default segment 40. FIG. 1 illustrates an example in which default segment 40 is composed only of state notification ECU 20. The number of ECUs belonging to default segment 40 is not particularly limited and may be two or more. Default segment 40 is an example of one or more second segments other than a first segment.

Travel control segment 50 may be composed of one or more devices among the devices that control travel operations of mobile object M such as running (traveling), turning, and stopping. The devices that control travel operations may include, for example, a device capable of controlling steering of mobile object M. FIG. 1 illustrates an example in which travel control segment 50 is composed only of ECU 30. The number of ECUs belonging to travel control segment 50 is not particularly limited and may be two or more. Travel control segment 50 is an example of a first segment related to travel.

The number of segments included in communication system 1 is not particularly limited so long as it is two or more, and may be three or more, for example. Each ECU belonging to each of the segments is connected to network device 10 in communication system 1.

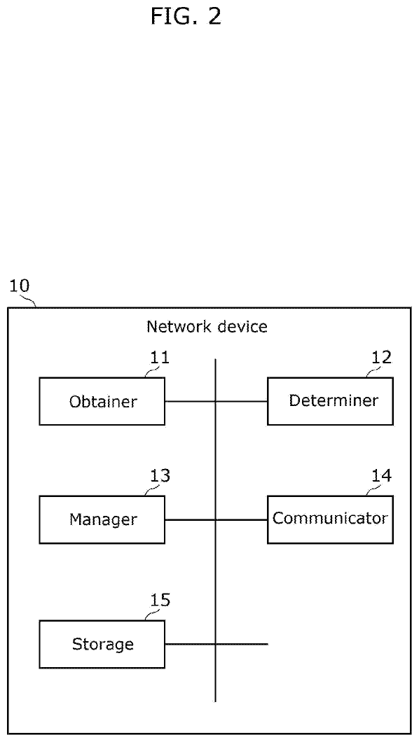

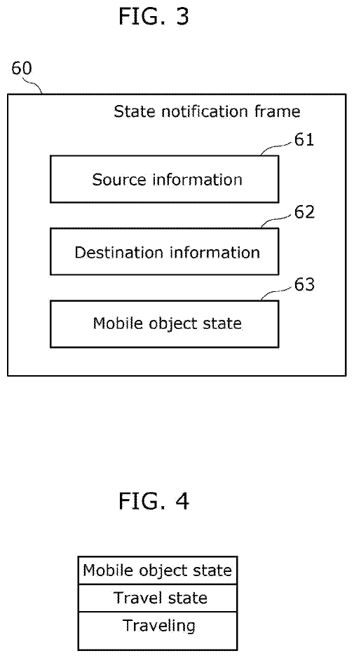

FIG. 2 is a block diagram illustrating the configuration of network device 10 according to this embodiment. Network device 10 executes a process of switching segments (ECUs constituting segments) according to a mobile object state based on state notification frame 60 (see FIG. 3 (described later)).

As illustrated in FIG. 2, network device 10 includes obtainer 11, determiner 12, manager 13, communicator 14, and storage 15. Part or all of the functional units included in network device 10 are implemented by a processor (for example, a central processing unit (CPU)) included in network device 10 executing a predetermined program using a memory.

Communicator 14 is a communication interface connected to the devices. Communicator 14 may include one or more wired communication interfaces (for example, Ethernet (registered trademark); the same applies hereinafter), include one or more wireless communication interfaces (for example, Wi-Fi (registered trademark); the same applies hereinafter), or include both types of communication interfaces. A wired communication interface includes a physical port to which a communication cable (hereinafter also simply referred to as a cable) is connected. A wireless communication interface includes a communication antenna and a wireless circuit.

Communicator 14 receives frames from the devices connected to network device 10, and transfers the received frames using results of determination by determiner 12 on whether frame transfer is possible (i.e., allowed).

Obtainer 11 obtains each frame received by communicator 14.

Determiner 12 determines whether the frame obtained by obtainer 11 is allowed to be transferred. Moreover, when the obtained frame is state notification frame 60, determiner 12 determines whether the mobile object state of mobile object M has changed.

Storage 15 holds tables and lists. The tables and lists held in storage 15 may be used when network device 10 performs segment setting and when network device 10 performs frame transfer control. For example, storage 15 may hold a mobile object state list, a segment list, a transfer control table, a frame rejection table, and a segment setting table. The tables and lists held in storage 15 will be described later with reference to FIGS. 4 to 6, 9, and 10. Storage 15 is implemented, for example, by a semiconductor memory or a hard disk drive (HDD), without being limited thereto.

Manager 13 manages which segment each ECU belongs to. For example, when determiner 12 determines that the mobile object state of mobile object M has changed or when determiner 12 determines that transfer of a frame is not allowed, manager 13 updates the lists held in storage 15.

When determiner 12 determines that the mobile object state of mobile object M has changed, manager 13 records the changed mobile object state in the mobile object state list held in storage 15. Manager 13 further updates the segment list such that the segments and segment configurations in communication system 1 correspond to the changed mobile object state.

When determiner 12 determines that transfer of a frame is not allowed, manager 13 updates the segment list held in storage 15 such that the source device of the frame (i.e. the device that has transmitted the frame) belongs to default segment 40. By this process, manager 13 isolates the source device that has transmitted the frame rejected to be transferred, from the segment to which the device has belonged into default segment 40. Security attacks on other devices in the segment to which the source device has belonged are thus suppressed. Instead of changing the source device to default segment 40, manager 13 may, for example, power off the source device or reject transfer of all frames transmitted by the source device to suppress security attacks. Rejecting transfer of all frames includes, for example, rejecting transfer of frames regardless of destination segment or frame type.

FIG. 3 is an explanatory diagram illustrating state notification frame 60 in this embodiment.

State notification frame 60 is an example of a frame. State notification frame 60 may be used when notifying a device connected to communication system 1 of the mobile object state of mobile object M.

State notification frame 60 includes source information 61, destination information 62, and mobile object state 63.

Source information 61 and destination information 62 are identifiers for uniquely identifying the source and destination of the frame. Source information 61 and destination information 62 may each be, for example, a media access control (MAC) address or an Internet Protocol (IP) address. In the case where the communication protocol is a message-addressing system, source information 61 may be empty, and destination information 62 may be an identifier for uniquely identifying the frame (for example, CAN-ID in the case where the communication protocol is CAN).

Mobile object state 63 indicates the state of mobile object M. Examples of mobile object state 63 include a travel state of mobile object M (such as traveling (i.e. running or in motion), stopped, or autonomous driving), an OTA state (such as no OTA or ECU 30 OTA in progress), a diagnostic state (such as no diagnosis or diagnosis of ECU 30 in progress), a charge/discharge state (such as no charging/discharging, charging, or discharging), and a connection state of an information processing terminal (such as no information processing terminal being connected or a smartphone being connected). Mobile object state 63 can be identified based on, for example, sensing results of various sensors mounted in mobile object M.

FIG. 4 is an explanatory diagram illustrating the mobile object state list in this embodiment.

The mobile object state list is a list for storing the mobile object state of mobile object M. The mobile object state list is held in storage 15 and may be updated by manager 13.

FIG. 4 illustrates, as the mobile object state, that the travel state is “traveling” (i.e., running or in motion).

The number and types of states included in the mobile object state indicated in the mobile object state list are not limited to the number (one) and type (travel state) illustrated in FIG. 4, and the number of states may be one or more and any other type of mobile object state may be included. The “other type of mobile object state” may be, for example, at least one from among an OTA state, a diagnostic state, a charge/discharge state, and a connection state of an information processing terminal.

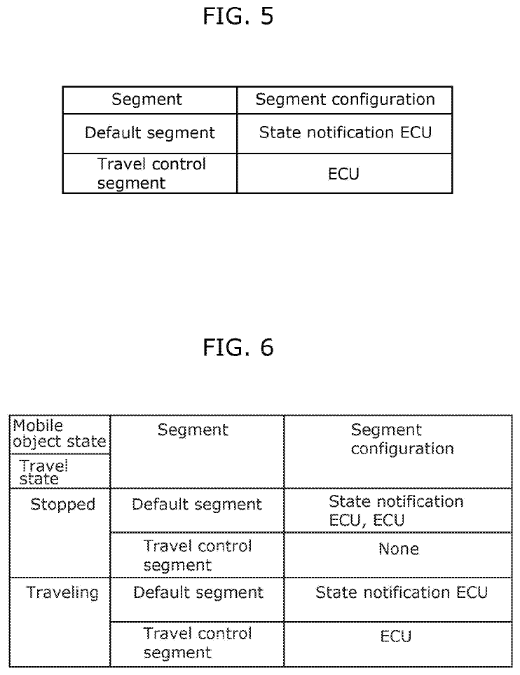

FIG. 5 is an explanatory diagram illustrating the segment list in this embodiment. FIG. 5 illustrates, as an example, the segment list in the case where the mobile object state is “traveling”. For example, the segment list is generated for each state of mobile object M.

The segment list is a list for storing the segments and segment configurations in communication system 1, i.e., the devices included in each segment. The segment list is held in storage 15 and may be updated by manager 13. For example, the segment list may be updated by manager 13 each time the mobile object state changes.

FIG. 5 illustrates, as the segments, default segment 40 and travel control segment 50. FIG. 5 also illustrates, as the segment configurations, state notification ECU 20 belonging to default segment 40 and ECU 30 belonging to travel control segment 50.

The segments indicated in the segment list are not limited to the two segments illustrated in FIG. 5 in terms of the number and types of segments, and the segment list may include one or more segments and may include at least one other type of segment. The at least one other type of segment may be, for example, at least one from among an OTA segment, a diagnostic segment, a charge/discharge segment, and an information processing terminal segment.

The segment configurations indicated in the segment list are not limited to the combinations of devices illustrated in FIG. 5, and the segment list may include any devices connected to communication system 1, and there may be a segment to which no device belongs.

In the case where the communication protocol is a message-addressing system, each segment configuration indicated in the segment list may be constituted by communication interfaces of communicator 14 instead of devices belonging to the corresponding segment.

FIG. 6 is an explanatory diagram illustrating the segment setting table in this embodiment. FIG. 6 illustrates what segment configuration is to be used for each mobile object state.

The segment setting table is a table for updating the segment list, and records, for each mobile object state, the segments and their segment configurations. The segment setting table may be held in storage 15.

The segment setting table illustrated in FIG. 6 indicates two travel states (stopped and traveling) as mobile object states, and the segments and their segment configurations in each mobile object state.

For example, in the segment setting table, in the case where the travel state is “stopped”, default segment 40 is composed of state notification ECU 20 and ECU 30, and travel control segment 50 is not composed of any device.

The mobile object states, segments, and segment configurations in the segment setting table may be updated in response to addition/removal of devices connected to communication system 1, addition/removal of device functions, and the like.

The mobile object states, segments, and segment configurations indicated in the segment setting table are not limited to those described above, and may be other mobile object states, segments, and segment configurations.

In the case where the communication protocol is a message-addressing system, each segment configuration indicated in the segment setting table may be constituted by communication interfaces of communicator 14 instead of devices belonging to the corresponding segment.

### 1-2. Operations in Communication System

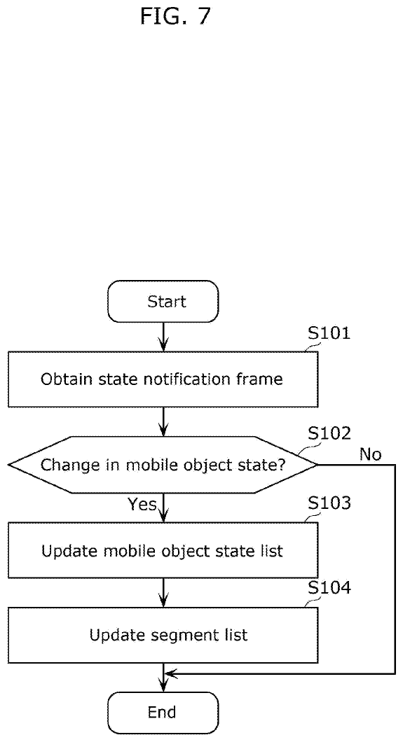

Next, operations in the communication system configured as described above will be described with reference to FIGS. 7 to 13. FIG. 7 is a flowchart illustrating a segment setting method (relay method) by network device 10 in this embodiment. FIG. 7 illustrates, as an example, a segment setting method by network device 10 when state notification ECU 20 transmits state notification frame 60.

In Step S101, obtainer 11 obtains state notification frame 60 that has been transmitted by state notification ECU 20 and received by communicator 14.

In Step S102, determiner 12 determines whether the mobile object state of mobile object M has changed. Determiner 12 compares the mobile object state indicated in the mobile object state list held in storage 15 (for example, the mobile object state indicated in previously obtained state notification frame 60) with mobile object state 63 indicated in state notification frame 60 obtained in Step S101, and determines that the mobile object state of mobile object M has changed to mobile object state 63 indicated in state notification frame 60 if the two mobile object states are different. When determiner 12 determines that the mobile object state has changed (Yes in S102), the process proceeds to Step S103. Otherwise (No in S102), the segment setting process by network device 10 ends.

In Step S103, manager 13 updates the mobile object state list held in storage 15 to indicate mobile object state 63 notified by state notification frame 60 obtained in Step S101 (that is, the latest state notification frame).

In Step S104, manager 13 updates the segment list held in storage 15 such that the segments and their segment configurations in communication system 1 correspond to the mobile object state updated in Step S103. First, manager 13 identifies, in the segment setting table, the segments and their segment configurations corresponding to the mobile object state indicated in the mobile object state list. Manager 13 then updates the segment list based on the identified segments and segment configurations. Step S104 is an example of a process in which a plurality of ECUs are classified into a plurality of segments according to the state of mobile object M. Manager 13 may reclassify the plurality of ECUs into a plurality of segments each time the state of mobile object M changes. The plurality of segments to be classified may be set for each state of mobile object M. For example, each time the state of mobile object M changes, the plurality of ECUs may be reclassified into the plurality of segments corresponding to the state of mobile object M after the change.

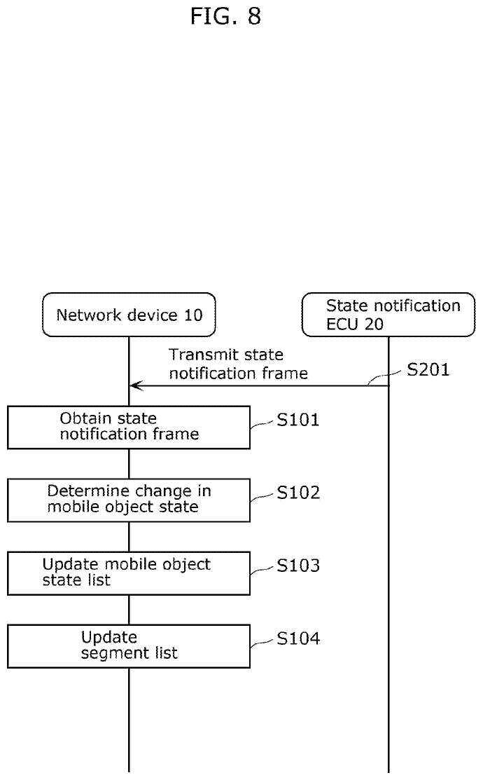

FIG. 8 is a sequence diagram illustrating segment update operation (relay method) in communication system 1 in this embodiment. The sequence diagram illustrated in FIG. 8 concerns the operation in communication system 1 in the case where state notification ECU 20 notifies network device 10 that the travel state is “traveling” using state notification frame 60. It is assumed that the mobile object state indicated in the mobile object state list is the travel state “stopped”. The process of updating the mobile object state list and the segment list in the case where the mobile object state changes from “stopped” to “traveling” will be described with reference to FIG. 8. The same steps as those illustrated in FIG. 7 are given the same reference signs, and their detailed description is omitted.

In Step S201, state notification ECU 20 transmits, to network device 10, state notification frame 60 including mobile object state 63 indicating that the travel state is “traveling”. Network device 10 obtains transmitted state notification frame 60 (S101).

In Step S102, since the travel state indicated in the mobile object state list is “stopped” and the travel state indicated as mobile object state 63 of state notification frame 60 is “traveling”, network device 10 determines that the travel state of mobile object M has changed from “stopped” to “traveling”.

In Step S103, network device 10 updates the travel state in the mobile object state list from “stopped” to “traveling”.

In Step S104, when the travel state is “traveling”, network device 10 identifies the segments and segment configurations corresponding to the travel state “traveling”, based on the segment setting table. Based on the identified segments and segment configurations, network device 10 updates the segment list such that default segment 40 is composed of state notification ECU 20 and travel control segment 50 is composed of ECU 30. Specifically, manager 13 in network device 10 updates the segment list such that default segment 40 is changed from being composed of state notification ECU 20 and ECU 30 to being composed of state notification ECU 20 and travel control segment 50 is changed from not being composed of any ECU to being composed of ECU 30.

Step S104 can be regarded as a process in which, when the travel state is “traveling”, network device 10 classifies the plurality of ECUs into travel control segment 50 related to travel and one or more other segments (default segment 40 in this example).

Through the above processing, network device 10 can update the segments and segment configurations in communication system 1 in response to changes in the mobile object state of mobile object M.

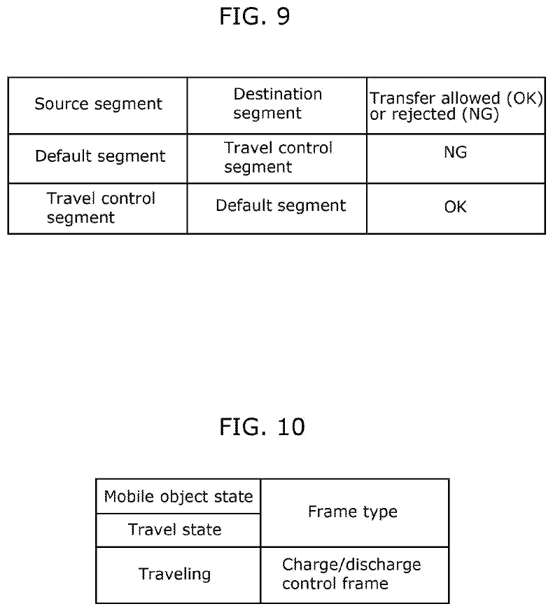

Communicator 14 transfers frames using results of determination by determiner 12 on whether frame transfer is possible (i.e., allowed), as mentioned above. Determiner 12 may determine whether frame transfer between different segments is allowed, according to predetermined transfer control information. A transfer control table, which is an example of the transfer control information, will be described with reference to FIG. 9.

FIG. 9 is an explanatory diagram illustrating a transfer control table for controlling frame transfer by network device 10 in this embodiment. The transfer control table may be held in storage 15.

The transfer control table illustrated in FIG. 9 includes: a source segment that is a segment to which a device indicated by source information of a frame belongs; a destination segment that is a segment to which a device indicated by destination information of the frame belongs; and an entry indicating whether transfer of the frame from the source segment to the destination segment is allowed (“OK”) or rejected (“NG”). FIG. 9 illustrates the transfer control table in the case where the mobile object state is “traveling”. The transfer control table may be individually set for each mobile object state, for example. The transfer control table is an example of a predetermined rule (first rule).

In FIG. 9, frame transfer from default segment 40 (second segment) to travel control segment 50 (first segment) is rejected. Default segment 40 is a segment unrelated to travel control. When the mobile object state is “traveling”, frame transfer from default segment 40 unrelated to travel control to travel control segment 50 related to travel control is rejected. Moreover, in FIG. 9, frame transfer from travel control segment 50 (first segment) to default segment 40 (second segment) is allowed. When the mobile object state is “traveling”, frame transfer from travel control segment 50 related to travel control to another segment unrelated to travel control is allowed. For example, when the mobile object state is “traveling” and default segment 40 includes a car navigation ECU that controls a car navigation system, a frame is transferred from travel control segment 50 to the car navigation ECU in order to perform display related to mobile object M. Meanwhile, frame transfer from the car navigation ECU to travel control segment 50 is rejected because the car navigation ECU does not perform control related to travel.

The source segments, destination segments, and entries of whether frame transfer is allowed or rejected in the transfer control table may be updated in response to addition/removal of devices connected to communication system 1, addition/removal of device functions, and the like.

The source segments, destination segments, and entries included in the transfer control table are not limited to those described above, and the transfer control table may include other source segments, destination segments, and entries.

When obtainer 11 receives a frame, determiner 12 can determine whether transfer of the frame is allowed using the transfer control table illustrated in FIG. 9 based on the segment to which the device indicated by the source information of the frame belongs and the segment to which the device indicated by the destination information of the frame belongs.

Even in the case where determiner 12 allows frame transfer according to the transfer control information, determiner 12 may end up rejecting the frame transfer using predetermined frame rejection information. A frame rejection table, which is an example of the frame rejection information, will be described with reference to FIG. 10.

FIG. 10 is an explanatory diagram illustrating a frame rejection table for controlling frame transfer by network device 10 in this embodiment. The frame rejection table may be held in storage 15.

The frame rejection table illustrated in FIG. 10 includes: a mobile object state; and a frame type for which transfer is rejected. The frame rejection table is an example of a predetermined rule (second rule).

For example, the frame rejection table indicates that, when the travel state is “traveling”, transfer of a charge/discharge control frame is rejected. Since charge/discharge control frames are not communicated during traveling, for example, even when a frame is allowed to be transferred from a source segment to a destination segment, the transfer is rejected if the frame is of a type included in the frame rejection table (a charge/discharge control frame in the example in FIG. 10).

Thus, the frame rejection table includes rejecting transfer of a predetermined type of frame when mobile object M is in a predetermined state.

The mobile object state and frame type in the frame rejection table may be updated in response to addition/removal of devices connected to communication system 1, addition/removal of device functions, and the like.

The mobile object state and frame type indicated in the frame rejection table are not limited to those illustrated in FIG. 10.

Based on the mobile object state indicated in the mobile object state list held in storage 15 and the frame type of the frame obtained by obtainer 11, determiner 12 can determine whether the transfer of the frame is possible (i.e., allowed) using the frame rejection table.

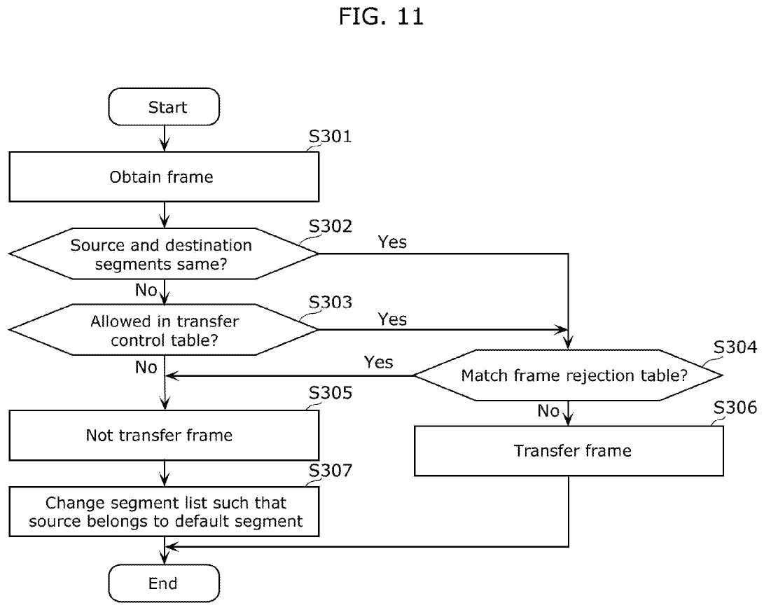

FIG. 11 is a flowchart illustrating a frame transfer method (relay method) by network device 10 in this embodiment. FIG. 11 illustrates operation of, after the plurality of ECUs are classified into a plurality of segments according to the state of mobile object M, controlling transmission and reception of frames between the plurality of segments.

In Step S301, obtainer 11 obtains a frame received by communicator 14.

In Step S302, determiner 12 determines whether the source (source segment) of the frame and the destination (destination segment) of the frame are the same segment. Determiner 12 determines whether the frame is allowed to be transferred based on whether the source and destination segments are the same segment.

First, determiner 12 identifies the source device and the destination device based on the source information and the destination information indicated in the frame. If the source information is empty, the source device may be a communication interface of communicator 14 that has received the frame. If the destination information is an identifier for uniquely identifying the frame, the destination device may be a device that processes the frame or a communication interface capable of communicating with the device that processes the frame.

Determiner 12 then identifies the source segment to which the source device belongs and the destination segment to which the destination device belongs, by referencing the segment list held in storage 15. If the source segment and the destination segment are the same (Yes in S302), the process proceeds to Step S304. If the source segment and the destination segment are different (No in S302), the process proceeds to Step S303.

In Step S303, determiner 12 determines whether the transfer of the frame is possible based on whether frame transfer from the source segment to the destination segment is allowed in the transfer control table. If the frame transfer is allowed (Yes in S303), the process proceeds to Step S304. If the frame transfer is rejected (No in S303), the process proceeds to Step S305. Step S303 can be regarded as a process in which transmission and reception of frames between the plurality of segments is controlled based on a predetermined rule (the transfer control table in this example) for transmission and reception of frames between the plurality of segments.

In Step S304, even in the case where determiner 12 allows the transfer of the frame in Step S302 or S303, determiner 12 eventually determines whether the transfer of the frame is not possible based on whether the mobile object state indicated in the mobile object state list held in storage 15 and the frame type of the frame obtained by obtainer 11 match the frame rejection table. If the mobile object state and the frame type match the frame rejection table (Yes in S304), the process proceeds to Step S305. If the mobile object state and the frame type do not match the frame rejection table (No in S304), the process proceeds to Step S306. Step S304 can be regarded as a process in which transmission and reception of frames between the plurality of segments is controlled based on a predetermined rule (the frame rejection table in this example) for transmission and reception of frames between the plurality of segments.

Thus, Step S304 may be performed if the result of determination on the frame in Step S303 is “Yes”. For example, a frame determined, using the transfer control table, to be allowed to be transferred may be subjected to determination of whether transfer is possible using the frame rejection table.

Thus, if the result of determination on the frame in Step S302 is “Yes”, whether to transfer the frame may be determined using only the frame rejection table out of the transfer control table and the frame rejection table. In other words, whether the type of the frame matches the frame type included in the frame rejection table may be determined.

If the result in Step S303 is No and if the result in Step S304 is Yes, determiner 12 determines to reject the transfer of the frame. If the result in Step S304 is No, determiner 12 determines to allow the transfer of the frame.

In Step S305, communicator 14 does not transfer the frame obtained by obtainer 11, as a result of determiner 12 determining to reject the transfer of the frame. Communicator 14 may transmit an error frame indicating that the transfer of the frame is rejected, to the source device of the frame.

In Step S306, communicator 14 transfers the frame obtained by obtainer 11 to the destination device, as a result of determiner 12 determining to allow the transfer of the frame.

In Step S307, manager 13 changes (updates) the segment list such that the source (source device) belongs to default segment 40 (an example of one or more other segments). Manager 13 changes the segment to which the source device belongs in the segment list held in storage 15, to default segment 40. For example, manager 13 changes, from among the plurality of ECUs, the ECU that has transmitted the frame determined not to be transferred based on a predetermined rule, to any of the one or more other segments (default segment 40 in this example).

As a result, the ECU related to the mobile object state and the source ECU that may be under attack belong to different segments, thereby improving security for the ECU related to the mobile object state.

Although an example of performing both determinations in Steps S303 and S304 is illustrated in FIG. 11, the present disclosure is not limited to such, only one of the determinations in Steps S303 and S304 may be performed. In other words, the transfer control table and/or the frame rejection table are used for determination in FIG. 11. In the case where network device 10 does not perform Step S304, network device 10 subjects frames transmitted and received between ECUs within the same segment to pass-through (i.e. transfer without determination of whether transfer is possible).

In Step S307, instead of changing the segment list, manager 13 may output an instruction to turn off the power of the source device that, among the plurality of ECUs, has transmitted the frame determined not to be transferred based on the predetermined rule, to the source device via communicator 14. In Step S307, instead of changing the segment list, manager 13 may discard each frame transmitted by the ECU (source device) that, among the plurality of ECUs, has transmitted the frame determined not to be transferred based on the predetermined rule.

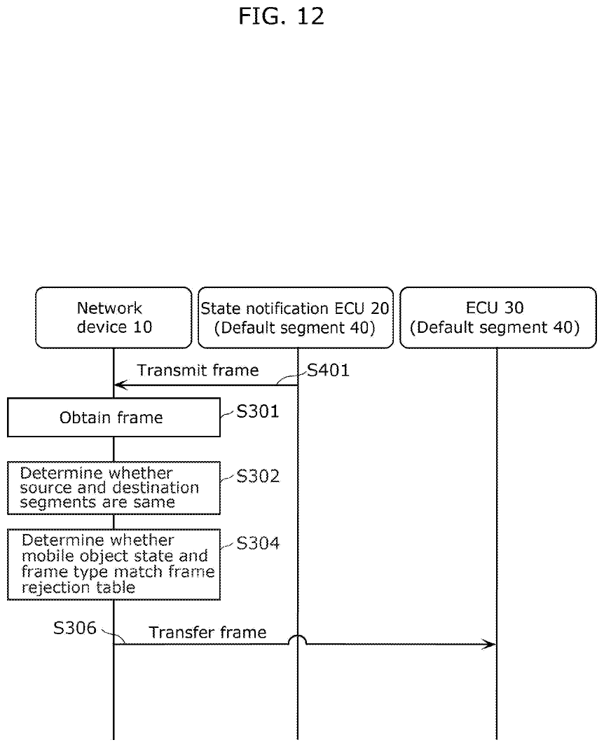

FIG. 12 is a first sequence diagram illustrating frame transfer operation (relay method) in communication system 1 in this embodiment. The sequence diagram illustrated in FIG. 12 concerns the operation in communication system 1 when state notification ECU 20 belonging to default segment 40 transmits a frame to ECU 30 equally belonging to default segment 40. It is assumed that the mobile object state indicated in the mobile object state list is the travel state “stopped”. It is also assumed that the transfer control table and the frame rejection table are as illustrated in FIGS. 9 and 10, respectively. The same steps as those illustrated in FIG. 11 are given the same reference signs, and their detailed description is omitted.

In Step S401, state notification ECU 20 transmits a frame. Network device 10 obtains the transmitted frame (S301).

In Step S302, network device 10 first identifies that the source device is state notification ECU 20 and the destination device is ECU 30, based on the source information and destination information of the frame. Network device 10 then identifies that both the source segment and the destination segment are default segment 40, by referencing the segment list. If the source segment and the destination segment are the same segment, network device 10 allows the frame to be transferred. Determiner 12 in network device 10 may uniformly allow transmission and reception of frames between ECUs within the same segment. In this case, the transfer control table and the frame rejection table are not used.

In Step S304, if the travel state indicated in the mobile object state list is not “traveling” and the frame type of the frame obtained by network device 10 is not a charge/discharge control frame, the mobile object state and the frame type do not match the frame rejection table, so that network device 10 allows the frame to be transferred. Step S304 corresponds to Step S304 in FIG. 11, in which whether the frame type of the frame matches the frame rejection table is determined.

In Step S306, network device 10 transfers the frame obtained in Step S301 to ECU 30, which is the destination device.

Through the above processing, network device 10 can transfer the frame transmitted by state notification ECU 20 to ECU 30.

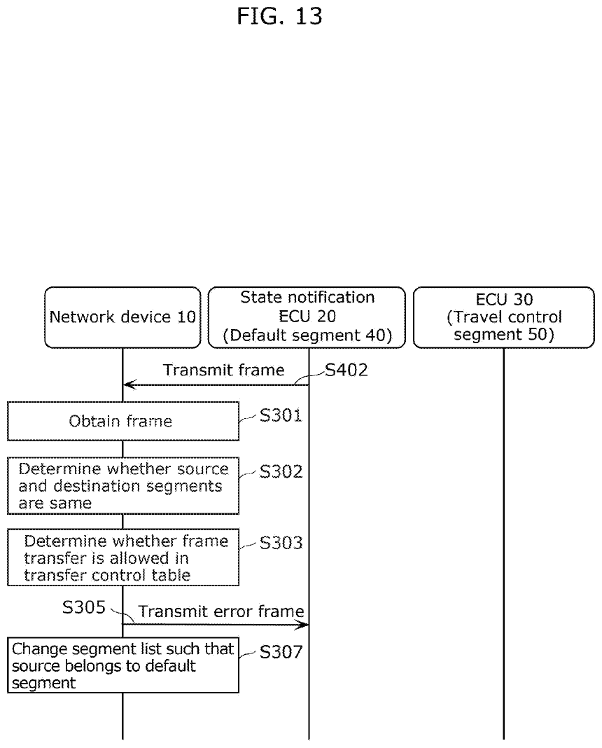

FIG. 13 is a second sequence diagram illustrating frame transfer operation (relay method) in communication system 1 in this embodiment. The sequence diagram illustrated in FIG. 13 concerns the operation in communication system 1 when state notification ECU 20 belonging to default segment 40 transmits a frame to ECU 30 belonging to travel control segment 50. It is assumed that the mobile object state indicated in the mobile object state list is the travel state “traveling”. It is also assumed that the transfer control table and the frame rejection table are as illustrated in FIGS. 9 and 10, respectively. The same steps as those illustrated in FIG. 11 are given the same reference signs, and their detailed description is omitted.

In Step S402, state notification ECU 20 transmits a frame. Network device 10 obtains the transmitted frame (S301).

In Step S302, network device 10 first identifies that the source device is state notification ECU 20 and the destination device is ECU 30, based on the source information and destination information of the frame. Network device 10 also identifies that the source segment is default segment 40 and the destination segment is travel control segment 50, by referencing the segment list. If the source segment and the destination segment are different, network device 10 determines whether the transfer of the frame is possible using the transfer control table.

In Step S303, network device 10 references the transfer control table. Since frame transfer from default segment 40 to travel control segment 50 is rejected when the travel state is “traveling”, network device 10 rejects the transfer of the frame. Step S303 corresponds to Step S303 illustrated in FIG. 11, in which whether frame transfer is allowed in the transfer control table is determined.

In Step S305, instead of transferring the frame obtained in Step S301 to ECU 30 as the destination device, network device 10 transmits, to state notification ECU 20 as the source device, an error frame indicating that the transfer of the frame is rejected.

In Step S307, network device 10 changes the segment of state notification ECU 20 as the source device, to default segment 40. For example, network device 10 may change the segment list such that the source belongs to default segment 40.

Through the above processing, if the travel state of mobile object M is “traveling”, network device 10 does not transfer, to ECU 30, a frame transmitted from state notification ECU 20. Thus, even if an attacker takes control of state notification ECU 20 and transmits a frame for security attack to ECU 30, ECU 30 belonging to travel control segment 50 can be protected from such attack when mobile object M is traveling. It is therefore possible to suppress security attacks under high risk conditions for mobile object M, such as during traveling.

As described above, network device 10 can suppress security attacks by changing the segments and segment configurations according to the mobile object state of mobile object M.

### Embodiment 2

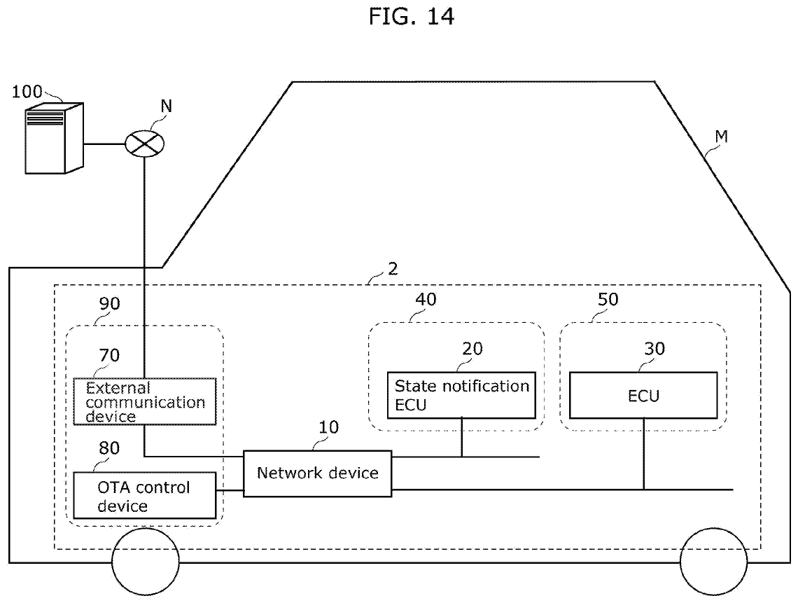

In this embodiment, a network device setting method, etc. capable of suppressing security attacks in a communication system of a mobile object will be described with reference to FIGS. 14 to 20.

### 2-1. Configuration of Communication System

First, the configuration of a communication system according to this embodiment will be described with reference to FIGS. 14 to 16.

In this embodiment, another configuration example of a network device capable of suppressing security attacks in a communication system of a mobile object will be described. In this embodiment, updating software of ECUs within mobile object M is assumed. In this embodiment, the mobile object state includes a software update state.

FIG. 14 is a schematic diagram illustrating the configuration of communication system 2 in this embodiment.

Communication system 2 illustrated in FIG. 14 is a communication system in a network of mobile object M, as with communication system 1 in FIG. 1.

Communication system 2 includes network device 10, external communication device 70, OTA control device 80, state notification ECU 20, and ECU 30.

Network device 10, state notification ECU 20, and ECU 30 are the same as network device 10, state notification ECU 20, and ECU 30 in FIG. 1.

External communication device 70 and OTA control device 80 correspond to devices connected to communication system 2 (hereinafter also simply referred to as devices).

The devices connected to communication system 2 are not limited to external communication device 70, OTA control device 80, state notification ECU 20, ECU 30, and network device 10.

Default segment 40 and travel control segment 50 are the same as default segment 40 and travel control segment 50 in FIG. 1.

OTA segment 90 is a segment that corresponds to a transfer range of communication frames (hereinafter also simply referred to as frames) transmitted by devices in the network of mobile object M. The segments are not limited to default segment 40, OTA segment 90, and travel control segment 50.

External network N may include an Internet service provider network, a mobile communication system (3rd Generation (3G), 4th Generation (4G), 5th Generation (5G), etc.), or the Internet.

External communication device 70 communicates with a communication device connected to external network N, such as OTA server 100. External communication device 70 may be, for example, a data communication module (DCM).

External communication device 70 is connected to external network N and is capable of communicating with communication devices connected beyond external network N. By transferring frames between external network N and network device 10, external communication device 70 enables communication between devices connected to network device 10 and communication devices connected beyond external network N. External communication device 70 is connected between external network N and network device 10.

OTA control device 80, by means of OTA technology, obtains information relating to a predetermined program from OTA server 100 which distributes programs via external communication device 70 or via the network, and updates a program of a device connected to communication system 2 based on the obtained program-related information.

OTA control device 80 may notify a device whether program update is being performed by OTA technology, using state notification frame 60 indicating an OTA state (such as no OTA or ECU 30 OTA in progress) at the start or end of OTA, for example.

OTA segment 90 is a segment defining a range constituting the network and serving as a frame transfer range. Specifically, the segment may be implemented by a VLAN, or implemented by a segment in SDN.

OTA segment 90 may be composed of any of a device subjected to OTA, a device that controls OTA, and a device that transmits OTA-related frames. For example, OTA segment 90 may be composed of external communication device 70 that can transfer frames including update programs, OTA control device 80 that controls program updates, and any device that can be subject to program update (for example, external communication device 70, OTA control device 80, network device 10, state notification ECU 20, or ECU 30).

FIG. 14 illustrates an example in which default segment 40 is composed only of state notification ECU 20, OTA segment 90 is composed of external communication device 70 and OTA control device 80, and travel control segment 50 is composed only of ECU 30.

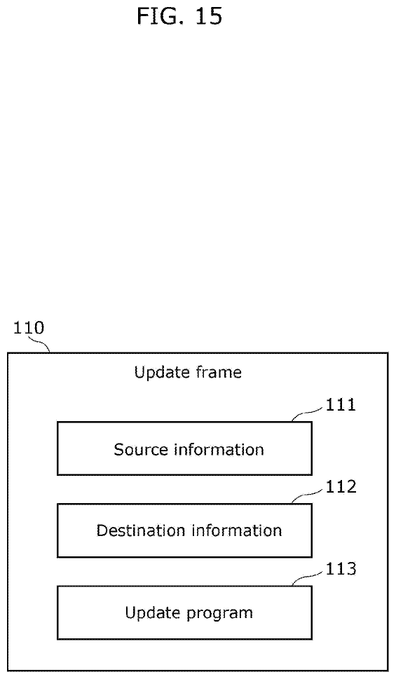

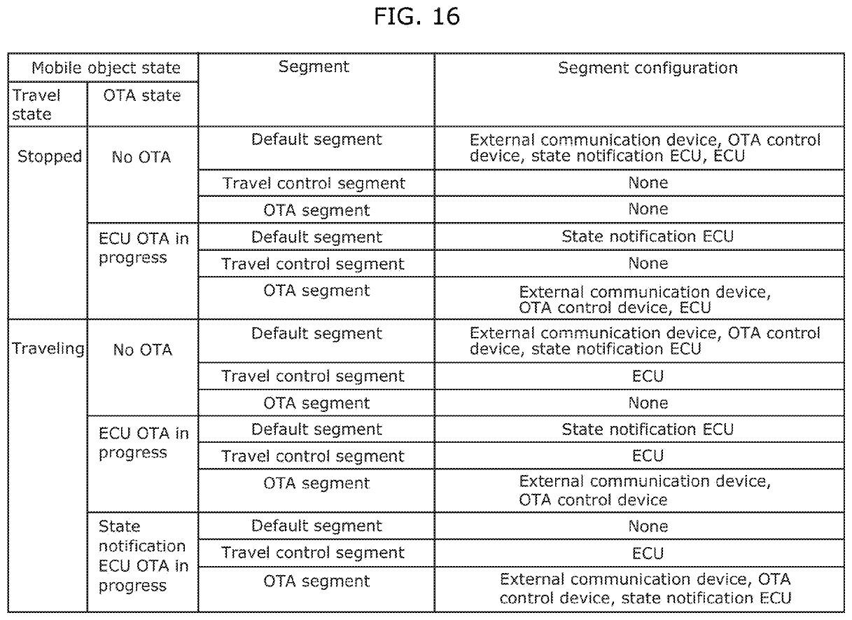

FIG. 15 is an explanatory diagram illustrating update frame 110 in this embodiment.

Update frame 110 is an example of a frame. Update frame 110 may be used when notifying an update target device of an update program.

Update frame 110 includes source information 111, destination information 112, and update program 113.

Source information 111 and destination information 112 are the same as source information 61 and destination information 62 in state notification frame 60 in FIG. 3.

Update program 113 is a program for updating firmware or software of a device connected to communication system 2. Update program 113 may be, for example, a patch for vulnerability of an ECU, a program for adding functions to an ECU, or information for updating a table held in storage 15.

FIG. 16 is an explanatory diagram illustrating a segment setting table in this embodiment. Although the OTA states when the travel state is “stopped” are two states, namely, “no OTA” and “ECU OTA in progress”, in FIG. 16, the OTA states may be three states, namely, “no OTA”, “ECU OTA in progress”, and “state notification ECU OTA in progress”, as when the travel state is “traveling”. Although the OTA states when the travel state is “traveling” are three states, namely, “no OTA”, “ECU OTA in progress”, and “state notification ECU OTA in progress”, in FIG. 16, the OTA states may be two states, namely, “no OTA” and “ECU OTA in progress”, as when the travel state is “stopped”.

The segment setting table is a table for updating the segment list, and records, for each mobile object state, the segments and their segment configurations. The segment setting table may be held in storage 15.

The segment setting table illustrated in FIG. 16 indicates combinations of two mobile object states (travel state and OTA state) and the segments and segment configurations for each combination of mobile object states.

For example, in the segment setting table, in the case where the travel state is “stopped” and the OTA state is “no OTA”, default segment 40 is composed of external communication device 70, OTA control device 80, state notification ECU 20, and ECU 30, and travel control segment 50 and OTA segment 90 are not composed of any device.

Thus, the segment setting table may include, as mobile object states, the travel state of mobile object M and the software update state (OTA state) of mobile object M. In this case, when the software update state indicates that software of mobile object M is being updated and the travel state is “traveling”, manager 13 may classify the plurality of ECUs into the travel control segment (first segment) related to travel, OTA segment 90 (third segment) related to software updating, and default segment 40 (one or more second segments other than the first and third segments). Combinations of three or more states may be used. Here, one ECU is classified so as to belong to any one of the plurality of segments.

The mobile object states, segments, and segment configurations in the segment setting table may be updated in response to addition/removal of devices connected to communication system 2, addition/removal of device functions, and the like.

The combinations of mobile object states, segments, and segment configurations indicated in the segment setting table are not limited to those described above, and may be other combinations of mobile object states, segments, and segment configurations. For example, at least two or more from among the travel state of mobile object M, the OTA state, the diagnostic state, the charge/discharge state, and the information processing terminal connection state may be used in combination.

In the case where the communication protocol is a message-addressing system, each segment configuration indicated in the segment setting table may be constituted by communication interfaces of communicator 14 instead of devices belonging to the corresponding segment.

### 2-2. Operations in Communication System

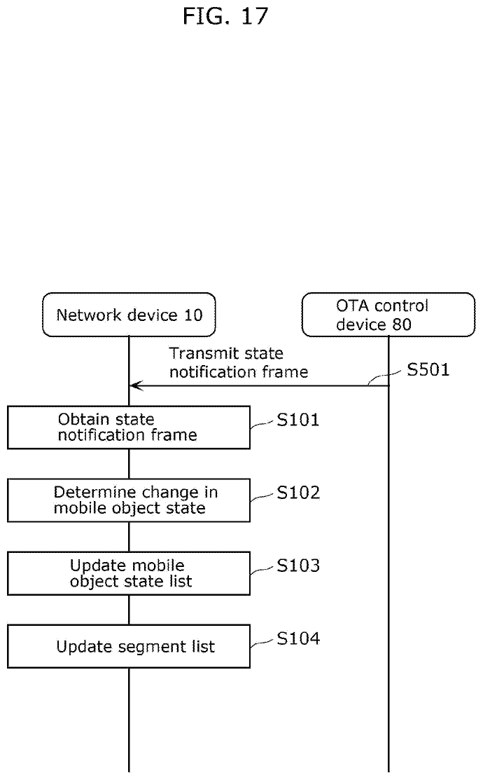

Next, operations in communication system 2 according to this embodiment will be described with reference to FIGS. 17 to 20.

FIG. 17 is a sequence diagram illustrating segment update operation (relay method) in communication system 2 in this embodiment. The sequence diagram illustrated in FIG. 17 concerns the operation in communication system 2 in the case where OTA control device 80 notifies network device 10 that the OTA state is “ECU 30 OTA in progress” using state notification frame 60. It is assumed that the mobile object state indicated in the mobile object state list is that the travel state is “traveling” and the OTA state is “no OTA”. The same steps as those illustrated in FIG. 7 are given the same reference signs, and their detailed description is omitted.

In Step S501, OTA control device 80 transmits, to network device 10, state notification frame 60 including mobile object state 63 indicating that the OTA state is “ECU 30 OTA in progress”. Network device 10 obtains transmitted state notification frame 60 (S101).

In Step S102, in the case where the OTA state indicated in the mobile object state list is “no OTA” and the OTA state indicated in mobile object state 63 in state notification frame 60 is “ECU 30 OTA in progress”, network device 10 determines that the OTA state has changed to “ECU 30 OTA in progress”.

In Step S103, network device 10 updates the OTA state in the mobile object state list to “ECU 30 OTA in progress”.

In Step S104, network device 10 identifies the segments and segment configurations corresponding to the travel state “traveling” and the OTA state “ECU 30 OTA in progress”, based on the segment setting table. Based on the identified segments and segment configurations, network device 10 updates the segment list such that default segment 40 is composed of state notification ECU 20, travel control segment 50 is composed of ECU 30, and OTA segment 90 is composed of external communication device 70 and OTA control device 80.

Thus, in the case where the software update state indicates that software of mobile object M is being updated, network device 10 classifies the plurality of ECUs into OTA segment 90 (first segment) related to software updating and one or more other segments (second segments). The one or more other segments include at least one of default segment 40 or travel control segment 50.

Through the above processing, network device 10 can update the segments and segment configurations in communication system 2 in response to changes in the mobile object state of mobile object M.

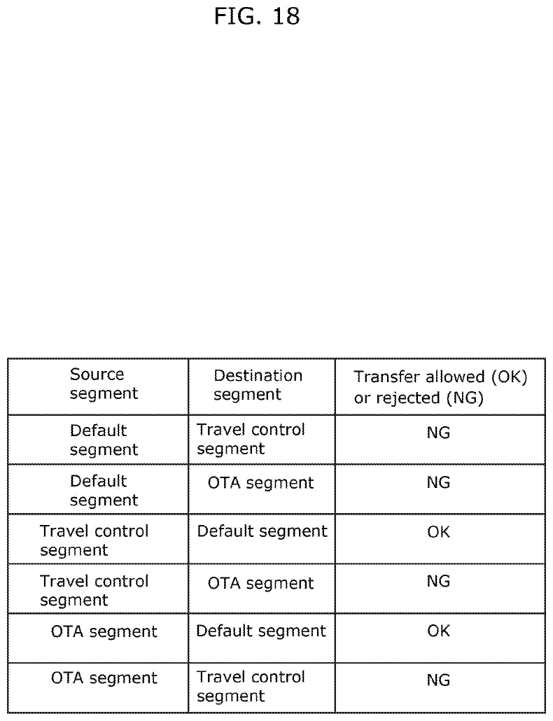

Communicator 14 transfers frames using results of determination by determiner 12 on whether frame transfer is possible (i.e., allowed), as mentioned above. Determiner 12 may determine whether frame transfer between different segments is allowed, according to predetermined transfer control information. A transfer control table, which is an example of the transfer control information, will be described with reference to FIG. 18.

FIG. 18 is an explanatory diagram illustrating a transfer control table for controlling frame transfer by network device 10 in this embodiment. The transfer control table may be held in storage 15.

The transfer control table illustrated in FIG. 18 includes: a source segment that is a segment to which a device indicated by source information of a frame belongs; a destination segment that is a segment to which a device indicated by destination information of the frame belongs; and an entry indicating whether transfer of the frame from the source segment to the destination segment is allowed (“OK”) or rejected (“NG”).

For example, the transfer control table indicates that frame transfer between segments other than default segment 40 (specifically, between OTA segment 90 and travel control segment 50) is rejected. The transfer control table also indicates that frame transfer from default segment 40 to segments other than default segment 40 is rejected. The transfer control table further indicates that frame transfer from segments other than default segment 40 to default segment 40 is allowed.

Specifically, the transfer control table indicates that transfer of a frame whose source is OTA segment 90 and whose destination is travel control segment 50 is rejected. The transfer control table also indicates that transfer of a frame whose source is OTA segment 90 and whose destination is default segment 40 is allowed. Other frames are as illustrated in FIG. 18.

The source segments, destination segments, and entries of whether frame transfer is allowed or rejected in the transfer control table may be updated in response to addition/removal of devices connected to communication system 2, addition/removal of device functions, and the like.

The source segments, destination segments, and entries included in the transfer control table are not limited to those described above, and the transfer control table may include other source segments, destination segments, and entries.

When obtainer 11 receives a frame, determiner 12 can determine whether transfer of the frame is allowed using the transfer control table illustrated in FIG. 18 based on the segment to which the device indicated by the source information of the frame belongs and the segment to which the device indicated by the destination information of the frame belongs.

In the example in FIG. 18, transfer between segments isolated from default segment 40 (between travel control segment 50 and OTA segment 90 in this example) is rejected. Since ECUs that communicate with each other are grouped into one segment, there is supposed to be no communication between different segments, and therefore frame transfer between segments is rejected.

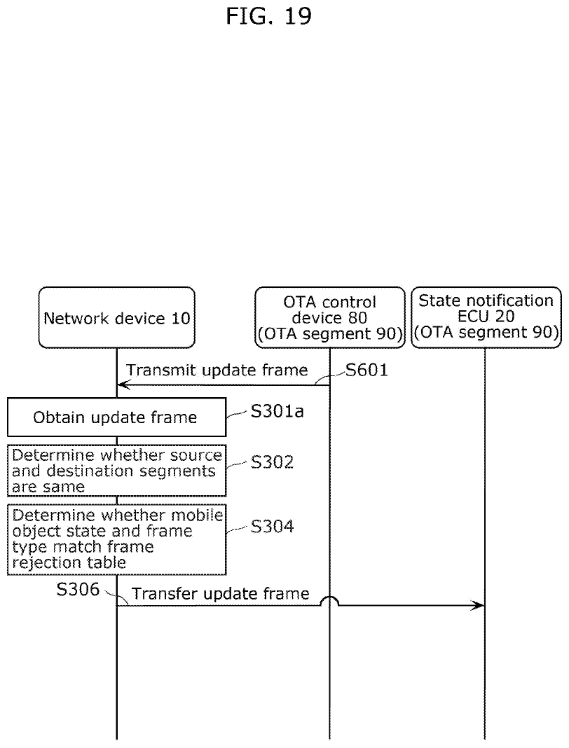

FIG. 19 is a first sequence diagram illustrating frame transfer operation (relay method) in communication system 2 in this embodiment. The sequence diagram illustrated in FIG. 19 concerns the operation in communication system 2 when OTA control device 80 belonging to OTA segment 90 transmits update frame 110 for updating firmware of state notification ECU 20 equally belonging to OTA segment 90. It is assumed that the mobile object state indicated in the mobile object state list is the travel state “traveling” and the OTA state “state notification ECU 20 OTA in progress”. It is also assumed that the transfer control table and the frame rejection table are as illustrated in FIGS. 18 and 10, respectively. The same steps as those illustrated in FIG. 11 are given the same reference signs, and their detailed description is omitted.

In Step S601, OTA control device 80 transmits update frame 110. Network device 10 obtains transmitted update frame 110 (S301a).

In Step S302, network device 10 first identifies that the source device is OTA control device 80 and the destination device is state notification ECU 20, based on source information 111 and destination information 112 of update frame 110. Network device 10 then identifies that both the source segment and the destination segment are OTA segment 90, by referencing the segment list. If the source segment and the destination segment are the same segment, network device 10 allows the frame to be transferred.

In Step S304, since the travel state indicated in the mobile object state list is “traveling” but the frame type of the frame obtained by network device 10 is not a charge/discharge control frame, the mobile object state and the frame type do not match the frame rejection table, so that network device 10 allows the frame to be transferred.

In Step S306, network device 10 transfers update frame 110 obtained in Step S301 to state notification ECU 20, which is the destination device.

Through the above processing, network device 10 can transfer, to state notification ECU 20, update frame 110 transmitted by OTA control device 80. Accordingly, even while mobile object M is traveling, the firmware of state notification ECU 20 can be updated.

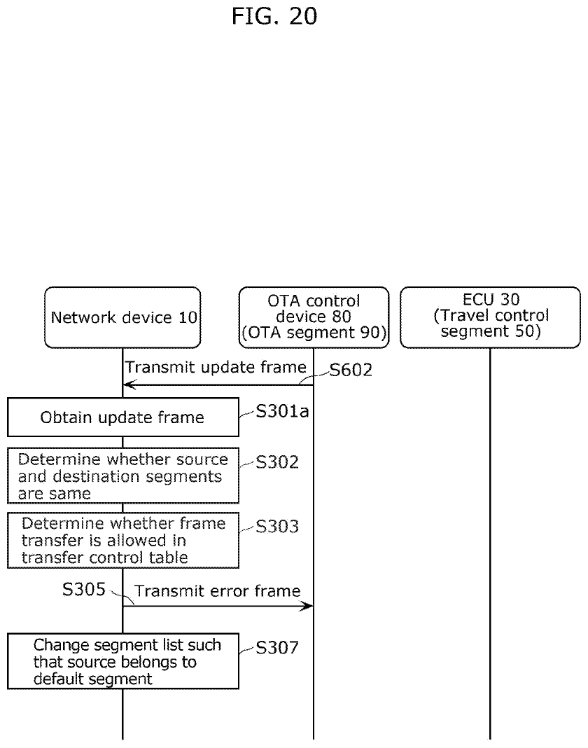

FIG. 20 is a second sequence diagram illustrating frame transfer operation (relay method) in communication system 2 in this embodiment. The sequence diagram illustrated in FIG. 20 concerns the operation in communication system 2 when OTA control device 80 belonging to OTA segment 90 transmits update frame 110 to ECU 30 belonging to travel control segment 50. It is assumed that the mobile object state indicated in the mobile object state list is the travel state “traveling” and the OTA state “ECU 30 OTA in progress”. It is also assumed that the transfer control table and the frame rejection table are as illustrated in FIGS. 18 and 10, respectively. The same steps as those illustrated in FIG. 11 are given the same reference signs, and their detailed description is omitted.

In Step S602, OTA control device 80 transmits update frame 110. Network device 10 obtains transmitted update frame 110 (S301a).

In Step S302, network device 10 first identifies that the source device is OTA control device 80 and the destination device is ECU 30, based on source information 111 and destination information 112 of update frame 110. Network device 10 also identifies that the source segment is OTA segment 90 and the destination segment is travel control segment 50, by referencing the segment list. If the source segment and the destination segment are different, network device 10 determines whether the transfer of the frame is possible using the transfer control table.

In Step S303, network device 10 references the transfer control table. Since frame transfer from OTA segment 90 to travel control segment 50 is rejected, network device 10 rejects the transfer of the frame.

In Step S305, instead of transferring update frame 110 obtained in Step S301 to ECU 30 as the destination device, network device 10 transmits, to OTA control device 80 as the source device, an error frame indicating that the transfer of the frame is rejected.

In Step S307, network device 10 changes the segment of OTA control device 80 as the source device, from OTA segment 90 to default segment 40.

Through the above processing, if the travel state of mobile object M is “traveling”, network device 10 does not transfer, to ECU 30, a frame transmitted from OTA control device 80. This prevents ECU 30 from operating according to update frame 110. Thus, even if an attacker takes control of OTA control device 80 and transmits a frame imitating update frame 110 to ECU 30, ECU 30 belonging to travel control segment 50 can be protected from such attack when mobile object M is traveling. It is therefore possible to suppress security attacks under high risk conditions for mobile object M, such as during traveling.

Moreover, through the above processing, network device 10 changes the segment of OTA control device 80 as the source device from OTA segment 90 to default segment 40. Therefore, any frame subsequently transmitted by OTA control device 80 is not transferred to OTA segment 90, based on the transfer control table. Even if an attacker takes control of OTA control device 80 and continues transmitting a frame imitating update frame 110, devices belonging to OTA segment 90 can be protected from such attack regardless of the travel state of mobile object M. Security attacks can thus be suppressed.

As described above, network device 10 can suppress security attacks by changing the segments and segment configurations according to the mobile object state of mobile object M.

### Embodiment 3

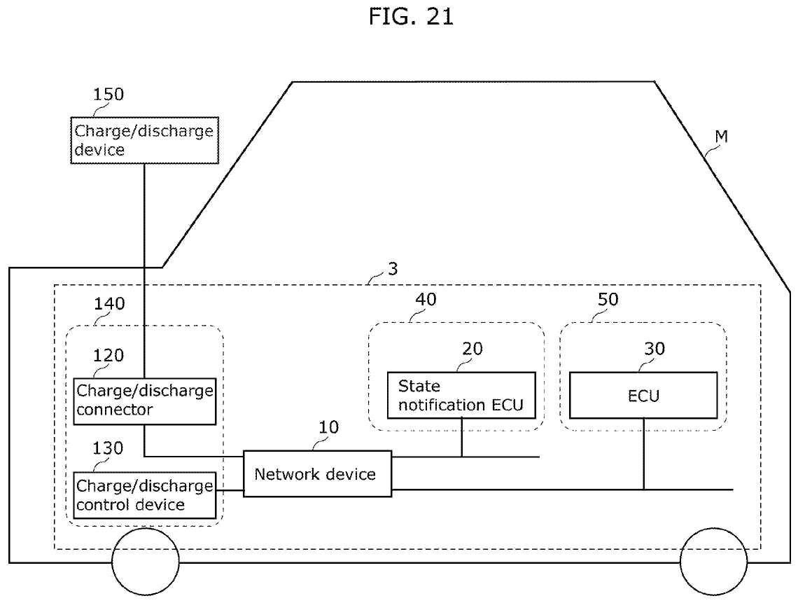

In this embodiment, another configuration example of a network device capable of suppressing security attacks in a communication system of a mobile object will be described with reference to FIGS. 21 to 28.

### 3-1. Configuration of Communication System

First, the configuration of a communication system according to this embodiment will be described with reference to FIGS. 21 to 23. FIG. 21 is a schematic diagram illustrating the configuration of communication system 3 in this embodiment.

Communication system 3 illustrated in FIG. 21 is a communication system in a network of mobile object M, as with communication system 1 in FIG. 1 and communication system 2 in FIG. 14.

Communication system 3 includes network device 10, charge/discharge connector 120, charge/discharge control device 130, state notification ECU 20, and ECU 30.

Network device 10, state notification ECU 20, and ECU 30 are the same as network device 10, state notification ECU 20, and ECU 30 in FIG. 1.

Charge/discharge connector 120 and charge/discharge control device 130 correspond to devices connected to communication system 3 (hereinafter also simply referred to as devices).

The devices connected to communication system 3 are not limited to charge/discharge connector 120, charge/discharge control device 130, state notification ECU 20, ECU 30, and network device 10.

Default segment 40 and travel control segment 50 are the same as default segment 40 and travel control segment 50 in FIG. 1.

Charge/discharge segment 140 is a segment that corresponds to a transfer range of communication frames (hereinafter also simply referred to as frames) transmitted by devices in the network of mobile object M. The segments are not limited to default segment 40, charge/discharge segment 140, and travel control segment 50.

Charge/discharge device 150 is a device that charges and discharges mobile object M. Charge/discharge device 150 may be, for example, electric vehicle supply equipment (EVSE) that charges an automobile.

Charge/discharge connector 120 is a connector for connecting charge/discharge device 150 to mobile object M. Charge/discharge connector 120 may be a connector conforming to an AC normal-charging standard such as SAE J1772, or a connector conforming to an AC rapid-charging standard such as CHAdeMO, CCS, GB/T, or NACS.

Charge/discharge connector 120 transfers frames between charge/discharge device 150 connected to mobile object M and network device 10, thereby enabling communication between charge/discharge device 150 and devices connected to network device 10.

Charge/discharge control device 130 is a device that controls the speed, timing, etc. of charging/discharging performed by charge/discharge device 150 on mobile object M. Charge/discharge control device 130 controls the speed and timing of charging/discharging by transmitting charge/discharge-related information to charge/discharge device 150. For example, charge/discharge control device 130 may control charging/discharging speed by transmitting, to charge/discharge device 150, charge/discharge-related information such as the battery status of mobile object M and the power used for charging/discharging, or control charging/discharging timing by transmitting a charge/discharge schedule of mobile object M.

Charge/discharge control device 130 may notify a device whether charging/discharging is being performed, using state notification frame 60 indicating a charge/discharge state (such as no charging/discharging, or charging/discharging) at the start or end of charging/discharging, for example.

Charge/discharge segment 140 is a segment defining a range constituting the network and serving as a frame transfer range. Specifically, the segment may be implemented by a VLAN, or implemented by a segment in SDN.

Charge/discharge segment 140 may be composed of any of a device for connecting charge/discharge device 150, a device that controls charging/discharging, and a device that transmits charge/discharge-related frames. For example, charge/discharge segment 140 may be composed of charge/discharge connector 120 that connects charge/discharge device 150 and is capable of transmitting charge/discharge-related frames, and charge/discharge control device 130 that controls charging/discharging.

FIG. 21 illustrates an example in which default segment 40 is composed only of state notification ECU 20, charge/discharge segment 140 is composed of charge/discharge connector 120 and charge/discharge control device 130, and travel control segment 50 is composed only of ECU 30.

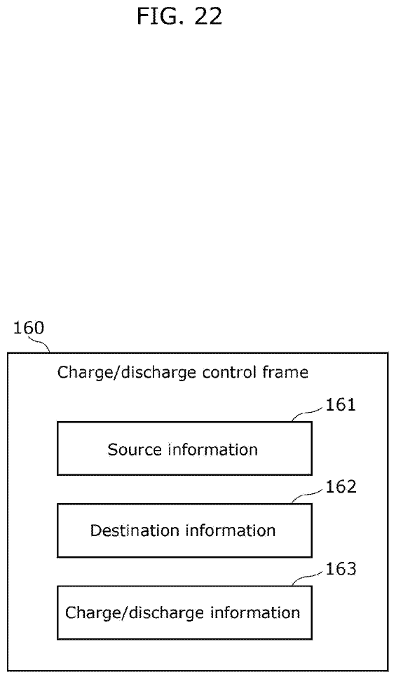

FIG. 22 is an explanatory diagram illustrating charge/discharge control frame 160 in this embodiment.

Charge/discharge control frame 160 is an example of a frame. Charge/discharge control frame 160 may be used when notifying devices and charge/discharge device 150 of charge/discharge-related information.

Charge/discharge control frame 160 includes source information 161, destination information 162, and charge/discharge information 163.

Source information 161 and destination information 162 are the same as source information 61 and destination information 62 in state notification frame 60 in FIG. 3.

Charge/discharge information 163 is information used to control the speed, timing, etc. of charging/discharging performed by charge/discharge device 150 on mobile object M. Charge/discharge information 163 may include, for example, the battery status of mobile object M, a charge/discharge schedule of mobile object M, and the charge/discharge power capability of charge/discharge device 150.

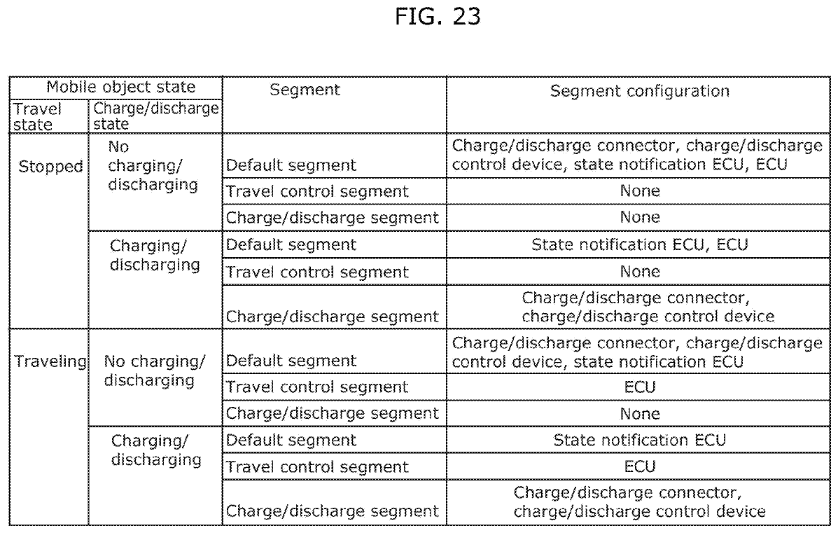

FIG. 23 is an explanatory diagram illustrating a segment setting table in this embodiment.

The segment setting table is a table for updating the segment list, and records, for each mobile object state, the segments and their segment configurations. The segment setting table may be held in storage 15.

The segment setting table illustrated in FIG. 23 indicates combinations of two mobile object states (travel state and charge/discharge state) and the segments and segment configurations for each combination of mobile object states.

For example, in the segment setting table, in the case where the travel state is “stopped” and the charge/discharge state is “no charging/discharging”, default segment 40 is composed of charge/discharge connector 120, charge/discharge control device 130, state notification ECU 20, and ECU 30, and travel control segment 50 and charge/discharge segment 140 are not composed of any device.

The mobile object states, segments, and segment configurations in the segment setting table may be updated in response to addition/removal of devices connected to communication system 3, addition/removal of device functions, and the like.

The combinations of mobile object states, segments, and segment configurations indicated in the segment setting table are not limited to those described above, and may be other combinations of mobile object states, segments, and segment configurations.

In the case where the communication protocol is a message-addressing system, each segment configuration indicated in the segment setting table may be constituted by communication interfaces of communicator 14 instead of devices belonging to the corresponding segment.

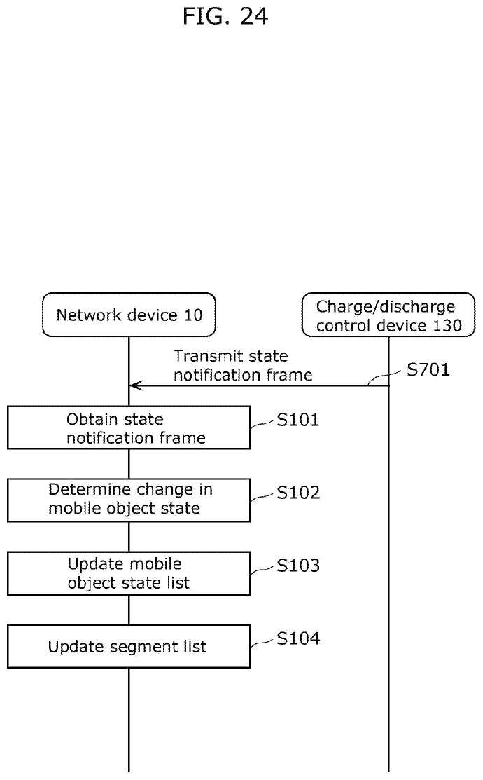

FIG. 24 is a sequence diagram illustrating segment update operation (relay method) in communication system 3 in this embodiment. The sequence diagram illustrated in FIG. 24 concerns the operation in communication system 3 in the case where charge/discharge control device 130 notifies network device 10 that the charge/discharge state is “charging/discharging” using state notification frame 60. It is assumed that the mobile object state indicated in the mobile object state list is that the travel state is “traveling” and the charge/discharge state is “no charging/discharging”. The same steps as those illustrated in FIG. 7 are given the same reference signs, and their detailed description is omitted.

In Step S701, charge/discharge control device 130 transmits, to network device 10, state notification frame 60 including mobile object state 63 indicating that the charge/discharge state is “charging/discharging”. Network device 10 obtains transmitted state notification frame 60 (S101).

In Step S102, since the charge/discharge state indicated in the mobile object state list is “no charging/discharging” and the charge/discharge state indicated in mobile object state 63 in state notification frame 60 is “charging/discharging”, network device 10 determines that the charge/discharge state has changed to “charging/discharging”.

In Step S103, network device 10 updates the charge/discharge state in the mobile object state list to “charging/discharging”.

In Step S104, network device 10 identifies the segments and segment configurations corresponding to the travel state “traveling” and the charge/discharge state “charging/discharging”, based on the segment setting table. Based on the identified segments and segment configurations, network device 10 updates the segment list such that default segment 40 is composed of state notification ECU 20, travel control segment 50 is composed of ECU 30, and charge/discharge segment 140 is composed of charge/discharge connector 120 and charge/discharge control device 130.

Thus, in the case where the charge/discharge state indicates that mobile object M is being charged/discharged, network device 10 classifies the plurality of ECUs into charge/discharge segment 140 (first segment) related to battery charge/discharge and one or more other segments (second segments). The one or more other segments include at least one of default segment 40 or travel control segment 50.

Through the above processing, network device 10 can update the segments and segment configurations in communication system 3 in response to changes in the mobile object state of mobile object M.

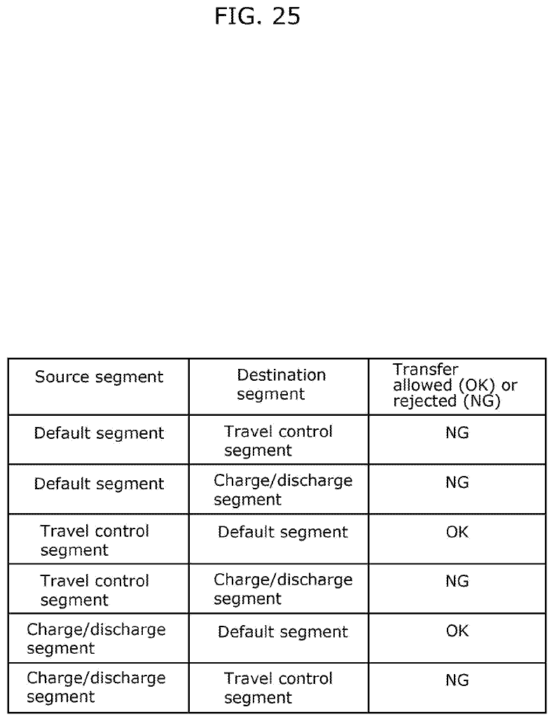

Communicator 14 transfers frames using results of determination by determiner 12 on whether frame transfer is possible (i.e., allowed), as mentioned above. Determiner 12 may determine whether frame transfer between different segments is allowed, according to predetermined transfer control information. A transfer control table, which is an example of the transfer control information, will be described with reference to FIG. 25.

FIG. 25 is an explanatory diagram illustrating a transfer control table for controlling frame transfer by network device 10 in this embodiment. The transfer control table may be held in storage 15.

The transfer control table illustrated in FIG. 25 includes: a source segment that is a segment to which a device indicated by source information of a frame belongs; a destination segment that is a segment to which a device indicated by destination information of the frame belongs; and an entry indicating whether transfer of the frame from the source segment to the destination segment is allowed (“OK”) or rejected (“NG”).

For example, the transfer control table indicates that frame transfer between segments other than default segment 40 (specifically, between charge/discharge segment 140 and travel control segment 50) is rejected. The transfer control table also indicates that frame transfer from default segment 40 to segments other than default segment 40 is rejected. The transfer control table further indicates that frame transfer from segments other than default segment 40 to default segment 40 is allowed.

Specifically, the transfer control table indicates that transfer of a frame whose source is charge/discharge segment 140 and whose destination is travel control segment 50 is rejected. The transfer control table also indicates that transfer of a frame whose source is charge/discharge segment 140 and whose destination is default segment 40 is allowed. Other frames are as illustrated in FIG. 25.

The source segments, destination segments, and entries of whether frame transfer is allowed or rejected in the transfer control table may be updated in response to addition/removal of devices connected to communication system 3, addition/removal of device functions, and the like.

The source segments, destination segments, and entries included in the transfer control table are not limited to those described above, and the transfer control table may include other source segments, destination segments, and entries.

When obtainer 11 receives a frame, determiner 12 can determine whether transfer of the frame is allowed using the transfer control table illustrated in FIG. 25 based on the segment to which the device indicated by the source information of the frame belongs and the segment to which the device indicated by the destination information of the frame belongs.

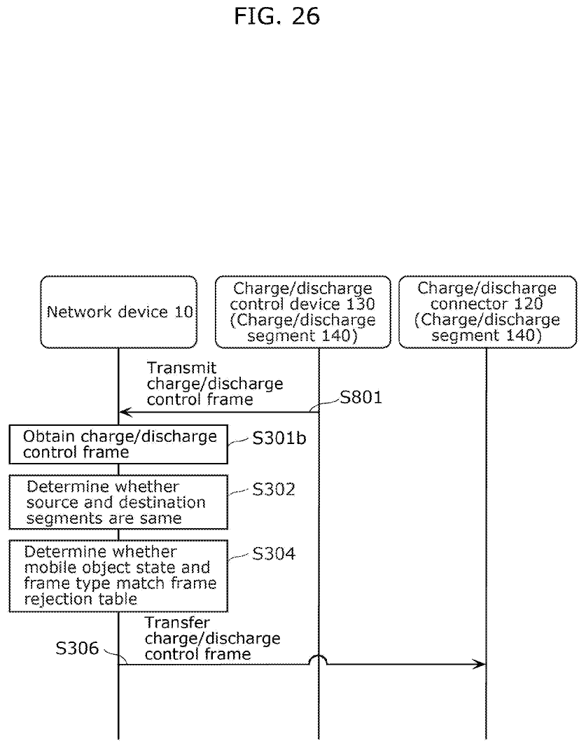

FIG. 26 is a first sequence diagram illustrating frame transfer operation (relay method) in communication system 3 in this embodiment. The sequence diagram illustrated in FIG. 26 concerns the operation in communication system 3 when charge/discharge control device 130 belonging to charge/discharge segment 140 transmits charge/discharge control frame 160 to charge/discharge connector 120 equally belonging to charge/discharge segment 140. It is assumed that the mobile object state indicated in the mobile object state list is the travel state “stopped” and the charge/discharge state “charging/discharging”. It is also assumed that the transfer control table and the frame rejection table are as illustrated in FIGS. 25 and 10, respectively. The same steps as those illustrated in FIG. 11 are given the same reference signs, and their detailed description is omitted.

In Step S801, charge/discharge control device 130 transmits charge/discharge control frame 160. Network device 10 obtains transmitted charge/discharge control frame 160 (S301b).

In Step S302, network device 10 first identifies that the source device is charge/discharge control device 130 and the destination device is charge/discharge connector 120, based on source information 161 and destination information 162 of charge/discharge control frame 160. Network device 10 then identifies that both the source segment and the destination segment are charge/discharge segment 140, by referencing the segment list. If the source segment and the destination segment are the same segment, network device 10 allows the frame to be transferred.

In Step S304, since the frame type of the frame obtained by network device 10 is a charge/discharge control frame but the travel state indicated in the mobile object state list is “stopped”, the mobile object state and the frame type do not match the frame rejection table, so that network device 10 allows the frame to be transferred.

In Step S306, network device 10 transfers charge/discharge control frame 160 obtained in Step S301b to charge/discharge connector 120, which is the destination device.

Through the above processing, network device 10 can transfer, to charge/discharge device 150 via charge/discharge connector 120, charge/discharge control frame 160 transmitted by charge/discharge control device 130. It is thus possible to control charging/discharging of mobile object M while mobile object M is stopped.

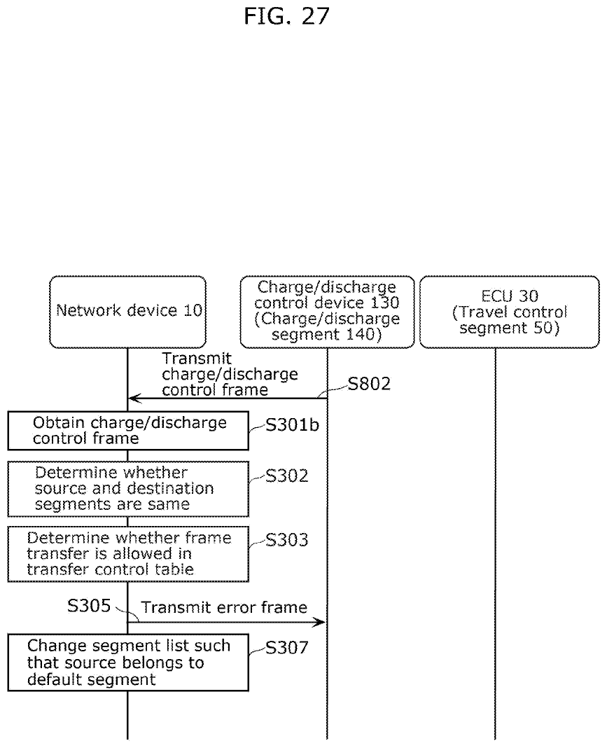

FIG. 27 is a second sequence diagram illustrating frame transfer operation (relay method) in communication system 3 in this embodiment. The sequence diagram illustrated in FIG. 27 concerns the operation in communication system 3 when charge/discharge control device 130 belonging to charge/discharge segment 140 transmits charge/discharge control frame 160 to ECU 30 belonging to travel control segment 50. It is assumed that the mobile object state indicated in the mobile object state list is the travel state “traveling” and the charge/discharge state “charging/discharging”. It is also assumed that the transfer control table and the frame rejection table are as illustrated in FIGS. 25 and 10, respectively. The same steps as those illustrated in FIG. 11 are given the same reference signs, and their detailed description is omitted.

In Step S802, charge/discharge control device 130 transmits charge/discharge control frame 160. Network device 10 obtains transmitted charge/discharge control frame 160 (S301b).

In Step S302, network device 10 first identifies that the source device is charge/discharge control device 130 and the destination device is ECU 30, based on source information 161 and destination information 162 of charge/discharge control frame 160. Network device 10 also identifies that the source segment is charge/discharge segment 140 and the destination segment is travel control segment 50, by referencing the segment list. If the source segment and the destination segment are different, network device 10 determines whether the transfer of the frame is possible using the transfer control table.

In Step S303, network device 10 references the transfer control table. Since frame transfer from charge/discharge segment 140 to travel control segment 50 is rejected, network device 10 rejects the transfer of the frame.

In Step S305, instead of transferring charge/discharge control frame 160 obtained in Step S301b to ECU 30 as the destination device, network device 10 transmits, to charge/discharge control device 130 as the source device, an error frame indicating that the transfer of the frame is rejected.

In Step S307, network device 10 changes the segment of charge/discharge control device 130 as the source device, from charge/discharge segment 140 to default segment 40.

Through the above processing, if the travel state of mobile object M is “traveling”, network device 10 does not transfer, to ECU 30, a frame transmitted from charge/discharge control device 130. Thus, even if an attacker takes control of charge/discharge control device 130 and transmits a frame imitating charge/discharge control frame 160 to ECU 30, ECU 30 belonging to travel control segment 50 can be protected from such attack when mobile object M is traveling. It is therefore possible to suppress security attacks under high risk conditions for mobile object M, such as during traveling.

Moreover, through the above processing, network device 10 changes the segment of charge/discharge control device 130 as the source device from charge/discharge segment 140 to default segment 40. Therefore, any frame subsequently transmitted by charge/discharge control device 130 is not transferred to charge/discharge segment 140, based on the transfer control table. Even if an attacker takes control of charge/discharge control device 130 and continues transmitting a frame imitating charge/discharge control frame 160, devices belonging to charge/discharge segment 140 can be protected from such attack regardless of the travel state of mobile object M. Security attacks can thus be suppressed.

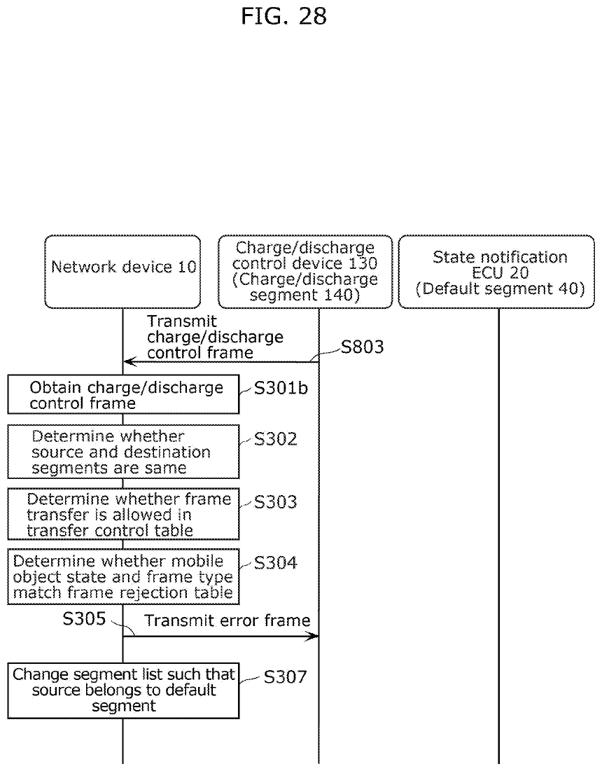

FIG. 28 is a third sequence diagram illustrating frame transfer operation (relay method) in communication system 3 in this embodiment. The sequence diagram illustrated in FIG. 28 concerns the operation in communication system 3 when charge/discharge control device 130 belonging to charge/discharge segment 140 transmits charge/discharge control frame 160 to state notification ECU 20 belonging to default segment 40. It is assumed that the mobile object state indicated in the mobile object state list is the travel state “traveling” and the charge/discharge state “charging/discharging”. It is also assumed that the transfer control table and the frame rejection table are as illustrated in FIGS. 25 and 10, respectively. The same steps as those illustrated in FIG. 11 are given the same reference signs, and their detailed description is omitted. FIG. 28 is a sequence diagram in the case where the frame rejection table is used to determine that transfer is rejected.

In Step S803, charge/discharge control device 130 transmits charge/discharge control frame 160. Network device 10 obtains transmitted charge/discharge control frame 160 (S301b).

In Step S302, network device 10 first identifies that the source device is charge/discharge control device 130 and the destination device is state notification ECU 20, based on source information 161 and destination information 162 of charge/discharge control frame 160. Network device 10 also identifies that the source segment is charge/discharge segment 140 and the destination segment is default segment 40, by referencing the segment list. If the source segment and the destination segment are different, network device 10 determines whether the transfer of the frame is possible using the transfer control table.

In Step S303, network device 10 references the transfer control table. Since frame transfer from charge/discharge segment 140 to default segment 40 is allowed, network device 10 allows the transfer of the frame.

In Step S304, the mobile object state indicated in the mobile object state list is the travel state “traveling” and the frame type of the frame obtained by network device 10 is a charge/discharge control frame, which matches the frame rejection table. Network device 10 accordingly rejects the transfer of the frame.

In Step S305, instead of transferring charge/discharge control frame 160 obtained in Step S301b to state notification ECU 20 as the destination device, network device 10 transmits, to charge/discharge control device 130 as the source device, an error frame indicating that the transfer of the frame is rejected.

In Step S307, network device 10 changes the segment of charge/discharge control device 130 as the source device, from charge/discharge segment 140 to default segment 40.

Through the above processing, given that it is difficult to perform charging/discharging by connecting charge/discharge device 150 to charge/discharge connector 120 when mobile object M is traveling, network device 10 does not transfer charge/discharge control frame 160, which conveys charge/discharge-related information, to state notification ECU 20. Thus, even if an attacker takes control of charge/discharge control device 130 and transmits a frame imitating charge/discharge control frame 160 to state notification ECU 20 despite mobile object M traveling, state notification ECU 20 can be protected from such attack. Security attacks can thus be suppressed.

As described above, network device 10 can suppress security attacks by changing the segments and segment configurations according to the mobile object state of mobile object M.

### Other Embodiments

In Embodiments 2 and 3 described above, as illustrated in FIGS. 18 and 25, only frame transfer from two segments corresponding to the mobile object state (travel control segment 50 and OTA segment 90 in FIG. 18, and travel control segment 50 and charge/discharge segment 140 in FIG. 25) to default segment 40 is allowed and frame transfer from one of the two segments to the other of the two segments is rejected. However, the present disclosure is not limited to such. For example, in the case where the plurality of segments include an autonomous driving control segment that includes one or more ECUs related to autonomous driving of mobile object M in addition to default segment 40 and travel control segment 50, the transfer control table may include allowing frame transfer from travel control segment 50 and the autonomous driving control segment to default segment 40 and rejecting frame transfer from default segment 40 to travel control segment 50 and the autonomous driving control segment, and may include allowing frame transfer from the autonomous driving control segment to travel control segment 50 and rejecting frame transfer from travel control segment 50 to the autonomous driving control segment. The autonomous driving control segment is, for example, a segment classified when the mobile object state is an autonomous driving state of performing autonomous driving. Thus, frame transfer between segments that need to cooperate for travel of mobile object M may be allowed. For example, frame transfer from one of the two segments corresponding to a mobile object state to the other of the two segments may be allowed, and frame transfer from the other of the two segments to the one of the two segments may be rejected.

Each structural element in each of the foregoing embodiments, etc. may be configured in the form of an exclusive hardware product, or may be implemented by executing a software program suitable for the structural element. Each structural element may be implemented by means of a program executing unit, such as a CPU or a processor, reading and executing the software program recorded on a recording medium such as a hard disk or semiconductor memory. Here, software that implements the network device, etc. in each of the foregoing embodiments is the following program.

The program causes a computer to execute a relay method used in a network device in an internal network of a mobile object, the internal network including a plurality of electronic control units that transmit and receive frames to and from each other via the network device, the relay method including: classifying the plurality of electronic control units into a plurality of segments according to a state of the mobile object; and controlling transmission and reception of frames between the plurality of segments. For example, one aspect of the present disclosure may be a computer program that causes a computer to execute the characteristic steps included in the relaying method illustrated in any of FIGS. 8, 11 to 13, 17, 19, 20, 24, and 26 to 28.

For example, the program may be a program to be executed by a computer. One aspect of the present disclosure may be a non-transitory computer-readable recording medium having such a program recorded thereon. For example, the program may be recorded on a recording medium and distributed or circulated. For example, by installing the distributed program in another device including a processor and causing the processor to execute the program, the processes can be performed by the device.

The order in which the steps are performed in each flowchart is an example provided for specifically describing the present disclosure, and order other than the above may be used. Part of the steps may be performed simultaneously (in parallel) with one or more other steps, and part of the steps may be omitted.

The division of the functional blocks in each block diagram is an example, and a plurality of functional blocks may be implemented as one functional block, one functional block may be divided into a plurality of functional blocks, or part of functions may be transferred to another functional block. Moreover, functions of a plurality of functional blocks having similar functions may be implemented by single hardware or software in parallel or in a time-sharing manner.

The network device according to each of the foregoing embodiments may be implemented as a single device or a plurality of devices. In the case where the network device is implemented by a plurality of devices, the structural elements in the network device may be assigned to the plurality of devices in any way. In the case where the network device is implemented by a plurality of devices, the communication method between the plurality of devices is not limited, and may be wireless communication or wired communication. The communication method may be a combination of wireless communication or wired communication.

Examples of mobile object M in each of the foregoing embodiments include an automobile, construction machinery, agricultural machinery, a ship, a railway vehicle, and an aircraft (e.g., an airplane or drone). The scope of application is not limited to mobile objects. Communication system 1 according to the present disclosure may be applied to communication networks used in industrial control systems such as factories or buildings, communication networks for controlling embedded devices, and the like. Mobile object M may be a manually drivable mobile object or an autonomously drivable mobile object (e.g., a fully autonomous vehicle or a semi-autonomous vehicle).

While network device 10, etc. according to one or more aspects have been described above by way of the embodiments, the present disclosure is not limited to these embodiments. Other modifications obtained by applying various changes conceivable by a person skilled in the art to the embodiments and any combinations of the elements in different embodiments without departing from the scope of the present disclosure are also included in the scope of one or more aspects.

### Industrial Applicability

The present disclosure is applicable to a network device that forms a network of a mobile object.

1. A relay method executed by a relay device in an internal network of a mobile object, the internal network including a plurality of electronic control units that transmit and receive frames to and from each other via the relay device, the relay method comprising:
classifying the plurality of electronic control units into a plurality of segments according to a state of the mobile object; and
controlling transmission and reception of frames between the plurality of segments.

2. The relay method according to claim 1,
wherein the state of the mobile object includes a travel state of the mobile object, and
in the classifying, when the travel state indicates that the mobile object is traveling, the plurality of electronic control units are classified into a first segment related to travel and one or more second segments other than the first segment.

3. The relay method according to claim 1,
wherein the state of the mobile object includes a software update state of the mobile object, and
in the classifying, when the software update state indicates that software of the mobile object is being updated, the plurality of electronic control units are classified into a first segment related to update of the software and one or more second segments other than the first segment.

4. The relay method according to claim 1,
wherein the state of the mobile object includes a charge/discharge state of a battery of the mobile object, and
in the classifying, when the charge/discharge state indicates that the battery of the mobile object is being charged or discharged, the plurality of electronic control units are classified into a first segment related to charge/discharge of the battery and one or more second segments other than the first segment.

5. The relay method according to claim 1,
wherein the state of the mobile object includes a travel state of the mobile object and a software update state of the mobile object, and
in the classifying, when the software update state indicates that software of the mobile object is being updated and the travel state indicates that the mobile object is traveling, the plurality of electronic control units are classified into a first segment related to travel, a third segment related to update of the software, and one or more second segments other than the first segment and the third segment.

6. The relay method according to claim 2,
wherein in the controlling, the transmission and reception of frames between the plurality of segments are controlled based on a predetermined rule for the transmission and reception of frames between the plurality of segments, the predetermined rule being in accordance with the state of the mobile object.

7. The relay method according to claim 6,
wherein a segment to which, among the plurality of electronic control units, an electronic control unit that has transmitted a frame determined not to be transferred based on the predetermined rule belongs is changed to any of the one or more second segments.

8. The relay method according to claim 6,
wherein an instruction is output to turn off power of an electronic control unit that has transmitted a frame determined not to be transferred based on the predetermined rule among the plurality of electronic control units.

9. The relay method according to claim 6,
wherein a frame transmitted by an electronic control unit that has transmitted a frame determined not to be transferred based on the predetermined rule among the plurality of electronic control units is discarded.

10. The relay method according to claim 6,
wherein the predetermined rule includes a first rule that allows transfer of a frame from the first segment to the one or more second segments and rejects transfer of a frame from the one or more second segments to the first segment.

11. The relay method according to claim 6,
wherein the predetermined rule includes a second rule that rejects transfer of a frame of a predetermined type when the mobile object is in a predetermined state.

12. The relay method according to claim 11,
wherein the predetermined rule further includes a first rule that allows transfer of a frame from the first segment to the one or more second segments and rejects transfer of a frame from the one or more second segments to the first segment, and
determination based on the second rule is performed on a frame that has been determined, based on the first rule, to be allowed to be transferred.

13. The relay method according to claim 12,
wherein when a source segment and a destination segment of the frame are same, whether the frame is allowed to be transferred is determined based on only the second rule out of the first rule and the second rule.

14. The relay method according to claim 1,
wherein the plurality of segments include a travel control segment including one or more electronic control units related to travel of the mobile object, an autonomous driving control segment including one or more electronic control units related to autonomous driving of the mobile object, and one or more other segments,
in the controlling, a predetermined rule for the transmission and reception of frames between the plurality of segments is used, the predetermined rule being in accordance with the state of the mobile object, and
the predetermined rule includes:
allowing transfer of a frame from the travel control segment and the autonomous driving control segment to the one or more other segments, and rejecting transfer of a frame from the one or more other segments to the travel control segment and the autonomous driving control segment; and
allowing transfer of a frame from the autonomous driving control segment to the travel control segment, and rejecting transfer of a frame from the travel control segment to the autonomous driving control segment.

15. The relay method according to claim 1,
wherein the classifying includes, each time the state of the mobile object changes, reclassifying the plurality of electronic control units into a plurality of segments according to the state of the mobile object after the change.

16. A relay device in an internal network of a mobile object, the internal network including a plurality of electronic control units that transmit and receive frames to and from each other via the relay device, the relay device:
classifying the plurality of electronic control units into a plurality of segments according to a state of the mobile object; and
controlling transmission and reception of frames between the plurality of segments.

17. A non-transitory computer-readable recording medium having recorded thereon a computer program for causing a computer to execute the relay method according to claim 1.
